(19) United States
(12) Patent Application Publication
(10) Pub. No.: US 2009/0268912 A1
(43) Pub. Date: Oct. 29, 2009

(54) DATA USE MANAGING SYSTEM

(76) Inventor: Masayuki Nakae, Tokyo (JP)

Correspondence Address: NEC CORPORATION OF AMERICA, 6535 N. STATE HWY 161, IRVING, TX, 75039, US

(21) Appl. No.: 12/439,909

(22) PCT Filed: Aug. 31, 2007
(86) PCT No.: PCT/JP2007/066976

§ 371 Date: Mar. 4, 2009

(30) Foreign Application Priority Data
Sep. 6, 2006 (JP) 2006-241963

(51) Int. Cl. H04K 1/00; H04L 9/08

(52) U.S. Cl. 380/270; 380/278

(57) ABSTRACT

[Problems] To provide a data use managing system which forces a face- to face permission by an administrator of confidential data when using the confidential data stored in mobile terminal.

[Means for Solving Problems] A user mobile terminal (2) transmits a use request token for requesting a use if encrypted confidential data to an administrator mobile terminal (1) by near-distance radio communication. If the administrator of the confidential data as the user of the administrator mobile terminal (1) performs a permission operation of use of the confidential data by the use mobile terminal (2) to the administrator mobile terminal (1), the administrator mobile terminal (1) transmits a permission token indicating the permission to use the confidential data to a right managing server (3). The right managing sever (3) transmits a decryption key to the user mobile terminal (2). The user mobile terminal (2) decrypted confidential data by the received key and user the confidential data by a predetermined use method.

### APPLICABLE FIELD IN THE INDUSTRY

The present invention relates to a data use managing system for managing a use of data, a method thereof, a data-use appliance, a program thereof, a server, a data management appliance, and a program thereof, and more particularly relates to a data use managing system for managing a use of data filed in a mobile terminal, a method thereof, a data-use appliance, a program thereof, a server, a data management appliance, and a program thereof.

### BACKGROUND ART

A use of mobile terminals such as a portable telephone and a personal digital assistant (PDA) has prevailed in such a manner that they are caused to store personal data such as a telephone directory and schedule information in some cases, or to reproduce amusement contents such as music and moving pictures in some cases.

In addition hereto, as the mobile terminal has been highly functionalized in recent years, it has become possible for the mobile terminal to share data with other mobile terminals, personal computers, digital household appliances other than these, etc. by employing a large-capacity portable memory device such as a SD memory card (Secure Digital memory card) in some cases, by employing a function of setting up a connection to a wire LAN (Local Area Network) and a wireless LAN in some cases, and by employing wireless near-by communication etc. (for example, Bluetooth (Registered Trademark) and infrared-ray communication) in some cases. From now on, it is thinkable that this technology is applied to a field for the collection and sharing of customer data employing a data sharing function, or the like.

Sharing data or the like necessitates limiting the groups, which use privacy information, and personal data, amusement contents, customer data, etc. that are shared based upon a copy right, a contract for confidentiality, and the like, to a specific user group and a group of specific appliances.

Additionally, in Patent document 1, the system for, responding to a request for making an access to data of a certain member filed in the mobile terminal by other members in a certain user group, sharing the above data is described. In the system described in the Patent document 1, when the mobile terminal of the member having received the access request cannot accept the access request for the reason of power intersection etc., the other mobile terminals having already shared the above data accept the access request in behalf of the mobile terminal having received the above access request.

In Patent document 2, the access right managing system is described in which when a certain user (access request source user) requests an access to data of another user (access request destination user), the latter makes a reference to an attribute certificate pre-bestowed upon the access request source user and the access request destination user, and accepts the above access request in the case that the position group described in the above attribute certificate is identical to its own group.

In Patent document 3, the system is described in which a plurality of digital appliances alone that have been connected to a home network via a wire or wireless communication link, has the registered ID, and have made an access within a predetermined time can share and reproduce identical amusement contents filed in a home sever.

In Patent document 4, the network access controlling method is described in which in a wire communication network or a wireless communication network, a physical position of an access switch (base station) being employed for a connection to a communication network is pre-registered in a server, and authenticated of the mobile terminal is carried out based upon two elements, i.e. an ID of the mobile terminal and the physical position of the access switch when the mobile terminal has been connected to the access switch.

In Patent document 5, the access controlling method is described of sharing personal data such as schedule information and a telephone directory filed in the server with other users via the mobile terminal.

Specifically, in advance, a scope of partial personal data (for example, with regard to a telephone directory, a telephone number, a name, etc.), which may be shared (disclosed), is defined as a rule between a user (request source user) who requests the sharing of data and a user (request destination user) who is requested to share data, and an electronic mail address that corresponds one-to-one to the above rule is defined. When the request source user requests an access to personal data of the request destination user via the mobile terminal, it transmits the access request and the request source user ID to the electronic-mail address that corresponds to a desired disclosure scope. The server having received the above access request makes a reference to the above rule, and transmits the above scope of the personal data to the access request source user only when the latter request source user has made a request for an access to the scope of the personal data permitted by the above rule.

In Patent document 6, the system is describe in which a license issuing device issues use license information that defines a licensed scope for digital contents, and creates a licensed electronic signature for the above information, and a decipher detects the license tampering of the above information based upon a public key and the generated electronic signature, and deciphers the ciphered digital contents according to the licensed scope that the above information defines.

In Patent document 7, the system is describe of delivering ciphered contents and a key for deciphering the ciphered contents that has been ciphered, and deciphering the deciphering key when the predetermined utilization conditions have been satisfied.

In Patent document 8, the method is described of deciding an output destination of data according to a pre-decided priority order.

Patent document 1: JP-P2003-189360A (paragraphs 0026 to 0057, and FIG. 1)

Patent document 2: JP-P2004-15507A (paragraphs 0038 to 0227, and FIG. 1)

Patent document 3: JP-P2004-334756A (paragraphs 0064 to 0101, and FIG. 1)

Patent document 4: JP-P2005-311781A (paragraphs 0013 to 0055, and FIG. 1)

Patent document 5: JP-P2006-53749A (paragraphs 0048 to 0060, and FIG. 1)

Patent document 6: JP-P2002-229447A (paragraphs 0035 to 0073, and FIG. 1)

Patent document 7: JP-P2003-87237A (paragraphs 0051 to 0144, and FIG. 1)

Patent document 8: JP-P1993-35519A (paragraphs 0006 to 0008, and FIG. 1)

### DISCLOSURE OF THE INVENTION

### Problems to be Solved by the Invention

However, even though any of the methods described in the Patent documents 1 to 8 is employed, an administrator (data administrator) of the confidential data such as personal data filed in the mobile terminal, amusement contents, and customer data cannot strictly manage a user of the confidential data (data user) with regard to a use of the confidential data.

For example, each of the methods described in the Patent documents 2, 4, and 5 is not a method of taking a control of not only the data user having the confidential data disclosed hereto, and but also the data user having shared the confidential data with regard to a use of the confidential data. For this, for example, the data user can cause the mobile terminal to store the disclosed confidential data, and furthermore can disclose the above confidential data to other users. That is, each of the methods described in the Patent documents 2, 4, and 5 cannot prohibit the confidential data from being used in a manner of going against a data administrator's intention.

Further, the system described in the Patent documents 1, which makes it possible to limit the partners to which the confidential data is re-disclosed to a member of the previously defined specific user group, cannot prevent the data user from causing a display means of the mobile terminal to display the confidential data in some cases, or from causing the mobile terminal to transmit the confidential data to other appliances in some cases.

Further, in the system described in the Patent document 3, it is the home server that carries out authentication of the digital appliance and transmission of the confidential data in the case that a plurality of the digital appliances that the data users have reproduce the confidential data; however it is difficult to realize such a home server function with the mobile terminal because a processing capacity of the mobile terminal and a communication network band for transmitting the confidential data are lacking.

Thereupon, the present invention has an object of providing a data use managing system for strictly managing the mobile terminal with regard to a use of the confidential data.

Yet further, the present invention has an object as well of providing a data use managing system that enables a data administrator and a data user existing in the vicinity of the above data administrator to share the confidential data.

### Means for Solving the Problem

A data use managing system in accordance with the present invention includes: a data-use appliance including decryption means for employing a decryption key for decrypting encrypted data, being data that has been encrypted, thereby to decrypt the encrypted data, and use request means for generating use request data for requesting permission of a use of the data, which includes encrypted data identification information for identifying the encrypted data, and transmitting it by near-distance wireless communication or causing display means to display the use request data; right management means including a database in which the decryption key, the encrypted data identification information, and administrator identification information indicating an administrator of the encrypted data have been stored correspondingly to each other, and decryption key transmission means for transmitting the decryption key to the data-use appliance; and a data management appliance including identification information transmission means for acquiring the use request data from the data-use appliance, and transmitting the administrator identification information and the encrypted data identification information that the use request data includes to the right management means, wherein the decryption key transmission means of the right management means, when having received the encrypted data identification information and the administrator identification information from the data management appliance, makes a reference to the database, and transmits the decryption key corresponding to the received encrypted data identification information and administrator identification information to the data-use appliance.

The decryption key, the encrypted data identification information, and the administrator identification information may be stored in the database correspondingly to right definition information indicating a method of using the data, the decryption key transmission means, when having received the encrypted data identification information and the administrator identification information from the data management appliance, may make a reference to the database, and transmit the decryption key and the right definition information corresponding to the received encrypted data identification information and administrator identification information to the data-use appliance, and the data-use-appliance may include use control means for using the data according to the use method that the received right definition information indicates.

The decryption key, the encrypted data identification information, and the administrator identification information may be stored in the database correspondingly to right definition information indicating a method of using the data and an output destination, the decryption key transmission means, when having received the encrypted data identification information and the administrator identification information from the data management appliance, may make a reference to the database, and transmit the decryption key and the right definition information corresponding to the received encrypted data identification information and administrator identification information to the data-use appliance, and the data-use appliance may include use control means for outputting the data to the output destination that the right definition information indicates, according to the use method and the output destination that the received right definition information indicates.

The data-use appliance may include authentication means for authenticating a device of the output destination of the data, and outputting the data to the device of the output destination responding to an authentication result.

The authentication means, when receiving from the device of the output destination of the data authentication information including information indicating the above device and determining that the received authentication information meets a predetermined authentication rule, may output the data to the device.

The use request means of the data-use appliance may generate use request data including user identification information indicating a user of the data, the data management appliance may include data acquisition means for acquiring the use request data from the data-use appliance, and input/output means for displaying the encrypted data identification information and the user identification information that the use request data acquired by the data acquisition means includes, and causing a user to input an instruction indicating whether or not the data-use appliance is permitted to use the data, and the identification information transmission means of the data management appliance may transmit the encrypted data identification information and the administrator identification information to the right management means when an instruction indicating that the data-use appliance is permitted to use the data has been inputted into the input/output means.

The data use managing system may include attribute certificate generation means for generating an attribute certificate indicating an attribute of a user of the data responding to a request by the data-use appliance, the use request means of the data-use appliance may generate use request data including the attribute certificate generated by the attribute certificate generation means, and the input/output means of the data management appliance may display the encrypted data identification information, the user identification information, and the attribute certificate that the use request data acquired by the data acquisition means includes, and cause the user to input an instruction indicating whether or not the data-use appliance is permitted to use the data.

The data use managing system may include a right transferee appliance including decryption means for decrypting the encrypted data by employing the decryption key, and use request means for generating use request data for requesting permission of a use of the data, which includes the encrypted data identification information, and transmitting it by near-distance wireless communication or causing display means to display the use request data, the data-use appliance may include right re-transfer means for, when having acquired the use request data from the right transferee appliance, determining whether or not to meet a re-transfer condition, being a condition that a right for using the data is transferred, input/output means for causing a user of the data-use appliance to determine whether or not the right transferee appliance is permitted to use the data, and data transmission means for transmitting re-transfer authorization data including the encrypted data identification information to the right management means when the right re-transfer means determines that the re-transfer condition of the right is met, and an instruction indicating that the right transferee appliance is permitted to use the data has been inputted into the input/output means, and the decryption key transmission means of the right management means, when having received the re-transfer authorization data, may transmit the decryption key to the right transferee appliance.

A data-use appliance in accordance with the present invention includes: decryption means for employing a decryption key for decrypting encrypted data, being data that has been encrypted, thereby to decrypt the encrypted data; and use request means for generating use request data for requesting permission of a use of the data, which includes encrypted data identification information for identifying the encrypted data, transmitting it by near-distance wireless communication or causing display means to display the use request data, and requesting an administrator of the encrypted data to use the data.

The data-use appliance may include use control means for using the data according to a use method that right definition information indicating a method of using the data indicates.

The data-use appliance may include: right re-transfer means for, when having acquired the use request data from other appliances, determining whether or not to meet a re-transfer condition, being a condition that a right for using the data is transferred; input/output means for causing a user to determine whether or not other appliances are permitted to use the data; and data transmission means for transmitting re-transfer authorization data including the encrypted data identification information to right management means for transmitting the decryption key when the right re-transfer means determines that the re-transfer condition of the right is met, and an instruction indicating that the other appliances are permitted to use the data has been inputted into the input/output means.

A server in accordance with the present invention includes: a database for storing a decryption key for decrypting encrypted data, being data that has been encrypted, encrypted data identification information for identifying the encrypted data, right definition information indicating a method of using the data, and administrator identification information indicating an administrator of the encrypted data correspondingly to each other; and decryption key transmission means for, when having received the encrypted data identification information and the administrator identification information from a first mobile appliance, transmitting to a second mobile appliance the decryption key and the right definition information caused to correspond to the encrypted data identification information and the administrator identification information stored in the database.

A data management appliance in accordance with the present invention includes: data acquisition means for acquiring use request data including encrypted data identification information for identifying encrypted data and user identification information indicating a user of the data, which indicates a request for permitting a use of the data, from a data-use appliance for using the data; and input/output means for displaying the encrypted data identification information and the user identification information that are included in the use request data acquired by the data acquisition means, and causing a user to input an instruction indicating whether or not the data-use appliance is permitted to use the data.

The data management appliance may include: encrypted data generation means for encrypting data, thereby to generate the encrypted data; and right definition means for generating right definition information indicating a method of using the data by the data-use appliance.

A data use managing method in accordance with the present invention includes: a use request step in which use request means generates use request data for requesting permission of a use of the data, which includes encrypted data identification information for identifying encrypted data, being data that has been encrypted, and transmits it by near-distance wireless communication or causes display means to display the use request data; an identification information transmission step in which identification information transmission means, when having acquired the use request data, transmits administrator identification information indicating an administrator of the encrypted data, and the encrypted data identification information that the use request data includes; a decryption key transmission step in which decryption key transmission means, when having received the administrator identification information and the encrypted data identification information transmitted in the identification information transmission step, makes a reference to a database for storing a decryption key, the encrypted data identification information, and the administrator identification information correspondingly to each other, and transmits the decryption key corresponding to the received administrator identification information and encrypted data identification information; and a decryption step in which decryption means employs the decryption key transmitted in the decryption key transmission step, thereby to decrypt the encrypted data.

A program in accordance with the present invention causes a computer to execute: employing a decryption key for decrypting encrypted data, being data that has been encrypted, thereby to decrypt the encrypted data; and generating use request data for requesting permission of a use of the data, which includes encrypted data identification information for identifying the encrypted data, transmitting it by near-distance wireless communication or causing display means to display the use request data, and requesting an administrator of the encrypted data to use the data.

A data managing program in accordance with the present invention causes a computer to execute: acquiring use request data including encrypted data identification information for identifying encrypted data and user identification information indicating a user of the data, which indicates a request for permitting a use of the data, from a data-use appliance for using the data; and displaying the encrypted data identification information and the user identification information being included in the use request data acquired in the data acquisition process in display means, and causing a user to input an instruction indicating whether or not the data-use appliance is permitted to use the data into input means.

### AN ADVANTAGEOUS EFFECT OF THE INVENTION

With the present invention, the data user is authorized to use the data in a face-to-face meeting with the data administrator, thereby making it possible to strictly manage a use of the data because the data-use appliance transmits the use request data via near-distance wireless communication, or the like.

Making a configuration so that the data-use appliance includes the use control means for using data according to the use method that the received right definition information indicates enables the method of using the data, in which the data-use appliance is employed, to be limited.

When a configuration is made so that the data-use appliance includes the use control means for outputting the data to the output destination that the right definition information indicates according to the use method and the output destination that the received right definition information indicates, the data administrator can designate not only whether or not the a use of the data is permitted over the data-use appliance that the data user employs, but also whether or not an output of the data to other appliances that are connected to the data-use appliance is permitted.

Making a configuration so that the data-use appliance includes the authentication means for authenticating the device of the output destination of the data enables the decrypted data (information) to be previously prevented from leaking to other devices.

Making a configuration so that the data use managing system includes the attribute certificate generation means for generating the attribute certificate indicating the attribute of the user of data responding to a request by the data-use appliance, and the use request means of the data-use appliance generates the use request data including the attribute certificate generated by the attribute certificate generation means enables a use of the data to be managed according to the attribute of the data user.

Making a configuration so that the data-use appliance includes the data transmission means for transmitting the re-transfer authorization data including the encrypted data identification information to the right management means when the right re-transfer means determines that the re-transfer condition of the right is met, and an instruction indicating that the right transferee appliance is permitted to use the data has been inputted into the input/output means enables the right for using the data to be re-transferred to the right transferee appliance.

### BRIEF DESCRIPTION OF THE DRAWINGS

FIG. 1 is a block diagram illustrating a configuration example of a first embodiment of the data use managing system of the present invention.

FIG. 2 is an explanatory view for explaining a configuration of the right management means.

FIG. 3 is a sequence block for explaining an operation in a second embodiment of the data use managing system.

FIG. 4 is a block diagram illustrating a configuration example of the second embodiment of the data use managing system of the present invention.

FIG. 5 is a block diagram illustrating a configuration example of the administrator mobile terminal into which the data encryption means has been integrated.

FIG. 6 is a block diagram illustrating a configuration example of the user mobile terminal in a third embodiment of the data use managing system of the present invention.

FIG. 7 is a flowchart for explaining an operation of outputting the confidential data to an external output device.

FIG. 8 is an explanatory view illustrating one example of a menu screen that the user input/output means displays.

FIG. 9 is an explanatory view illustrating an example of a table that is employed in the third embodiment.

FIG. 10 is an explanatory view illustrating one example of a table of correspondence of a use method, a character string being displayed in the menu screen, and an output destination interface.

FIG. 11 is an explanatory view illustrating one example of a table of correspondence of a use method, a character string being displayed in the menu screen, an output destination interface, and an output destination device.

FIG. 12 is a block diagram illustrating a configuration example of the user mobile terminal and the external output device of a fourth embodiment.

FIG. 13 is an explanatory view illustrating one example of profile information stored by a profile file means of the external output device.

FIG. 14 is an explanatory view illustrating an example of the authentication rule.

FIG. 15 is a flowchart for explaining an operation of outputting the confidential data to the external output device.

FIG. 16 is a block diagram illustrating a configuration example of a fifth embodiment of the data use managing system of the present invention.

FIG. 17 is an explanatory view illustrating one configuration example of AC generation means.

FIG. 18 is a sequence block for explaining an operation in the fifth embodiment of the data use managing system.

FIG. 19 is an explanatory view illustrating one example of a directory structure of an attribute database.

FIG. 20 is an explanatory view illustrating one example of a format of the attribute certificate.

FIG. 21 is a block diagram illustrating a configuration example of a sixth embodiment of the data use managing system of the present invention.

FIG. 22 is a sequence block for explaining an operation of the sixth embodiment of the present invention.

FIG. 23 is an explanatory view illustrating a configuration example of a second right certificate.

### DESCRIPTION OF NUMERALS

1, 5, 6, and 120 administrator mobile terminals
2 and 7 user mobile terminals
3 right management server
4 data encryption means
8 external output device
10 and 20 user input/output means
11 and 21 right transfer means
12 and 23 data file means
14 first data user mobile terminal
15 second data user mobile terminal
22 use control means
24 and 25 certificate file means
31 right management means
71 output control means
91 output device authentication means
100 external output device
101 profile file means
102 output means
110 attribute certificate server
111 attribute database
112 AC generation means
113 key pair file means
121 AC authentication means
131 AC acquisition means
141 second right transfer means
311 confidential data information file means

### BEST MODE FOR CARRYING OUT THE INVENTION

### Embodiment 1

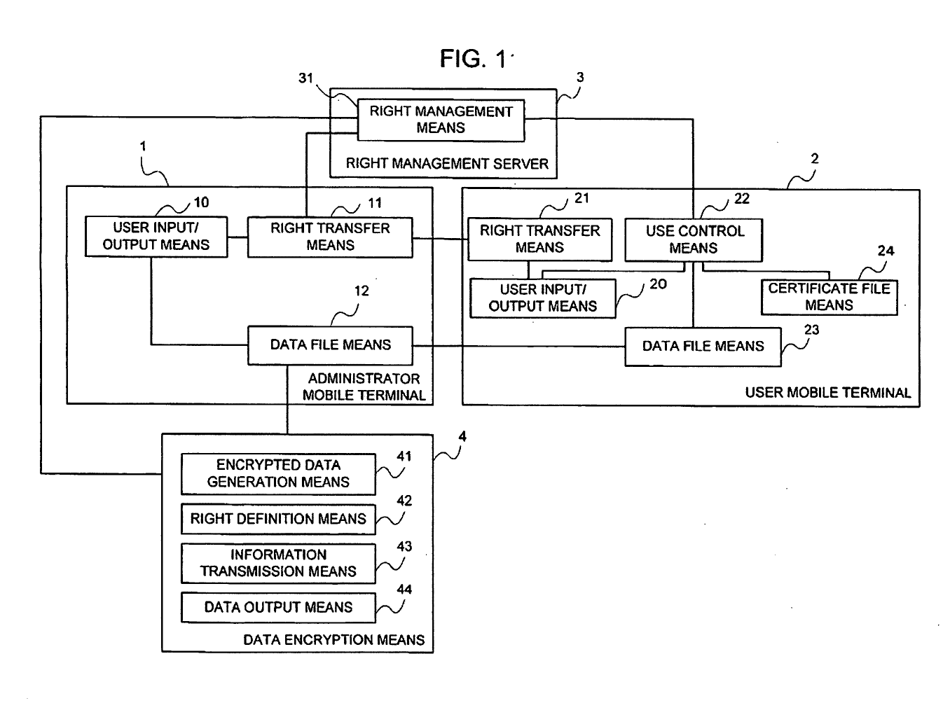

The first embodiment of the data use managing system of the present invention will be explained by making a reference to the accompanied drawings. FIG. 1 is a block diagram illustrating a configuration example of the first embodiment of the data use managing system of the present invention.

The data use managing system shown in FIG. 1 includes an administrator mobile terminal (data management appliance) 1 that is employed by the data administrator for managing the confidential data, a user mobile terminal (data-use appliance) 2 that is employed by the data user for using the confidential data, a right management server (server) 3, and data encryption means 4.

Each of the administrator mobile terminal 1 and the user mobile terminal 2 includes, for example, communication means (not shown in the figure), being a network device or a device for reading off two-dimension barcodes. Herein, the so-called network device, which is communication means for making data communication with other appliances, is, for example, a device for making infrared-ray communication, a device for making communication by Bluetooth, a wireless LAN terminal, a device for making communication with other appliances by a CDMA (Code Division Multiple Access) technique, a device for setting up an Ethernet (Registered Trademark) connection to LAN, and a device for making communication with other appliances via Internet.

Additionally, the device for making near-distance wireless communication such as infrared-ray communication and Bluetooth that the communication means of the administrator mobile terminal 1 includes is employed for communication with the user mobile terminal 2. And, the device for making near-distance wireless communication such as infrared-ray communication and Bluetooth that the communication means of the user mobile terminal 2 includes is employed for communication with the administrator mobile terminal 1. Thus, the communication between the administrator mobile terminal 1 and the user mobile terminal 2 is made in the case that the data user is positioned in the vicinity of the data administrator (for example, in a situation where the data user and the data administrator face each other).

Further, the device for making near-distance wireless communication such as infrared-ray communication and Bluetooth that the communication means of the administrator mobile terminal 1 includes, and the device for making communication with other appliances via Internet are employed for communication with the data encryption means 4.

Further, the device for making communication with other appliances via Internet that the communication means of the administrator mobile terminal 1 and the user mobile terminal 2 include is employed for communication with the right management server 3. Additionally, the administrator mobile terminal 1 and the user mobile terminal 2 may employ different right control servers for each encrypted data being used.

The administrator mobile terminal 1 includes a user input/output means (input/output means) 10, a right transfer means (identification information transmission means and data acquisition means) 11, and data file means 12.

The user input/output means 10 includes, for example, display means such as a liquid crystal display (LCD: Liquid Crystal Display), and input means such as a keyboard. The user input/output means 10 displays a screen for requesting authorization of a use of the confidential data. Further, the data administrator inputs an instruction for authorizing a use of the confidential data, for browsing (displaying) the encrypted confidential data filed in the data file means 12, for transmission to the other appliances, or the like into the user input/output means 10.

The right transfer means 11 acquires information from right transfer means 21 of the user mobile terminal 2. Further, when an operation of authorizing a use of the confidential data has been performed for the user input/output means 10 by the data administrator, the right transfer means 11 generates an authorization token, being information including a confidential data ID (encrypted data identification information) for identifying the encrypted confidential data, a data user ID (user identification information) for identifying the user of the user mobile terminal 2, and an administrator ID (administrator identification information) for identifying the user of the administrator mobile terminal 1, and transmit it to the right management server 3.

The data file means 12, which includes, for example, non-volatile storage devices such as a flash memory and a hard disc, files the confidential data that has been encrypted (encrypted confidential data). Further, data file means 12, according to an operation performed for the user input/output means 10, prepares a list of the encrypted confidential data that has been filed therein, and presents it to the data administrator via the user input/output means 10 in some cases, or outputs specific encrypted confidential data to the other mobile terminals in some cases.

Further, the SD memory card or the USB (Universal Serial Bus) key may file the encrypted confidential data as the data file means 12. Further, the data file means 12 may receive and file the encrypted confidential data from the data encryption means 4 by communication via infrared-ray communication, Bluetooth, or Internet.

The user mobile terminal 2 includes a user input/output means 20, a right transfer means (use request means) 21, use control means (decryption means) 22, data file means 23, and certificate file means 24.

The user input/output means 20 includes, for example, display means such as a liquid crystal display, and input means such as a keyboard. The user input/output means 20 presents a list of the encrypted confidential data filed in the data file means 23 to the data user in some cases, conveys a use request operation by the data user to the right transfer means 21 in some cases, or conveys an operation performed by the data user to the use control means 22 in some cases.

The right transfer means 21, according to an operation performed for the user input/output means 20 by the data user, generates a use request token as use request data, being information indicating a request for using the encrypted confidential data filed in the data file means 23, which includes the confidential data ID and the data user ID.

The use control means 22 includes, for example, a non-volatile storage device having a decryption program and a moving picture reproduction program filed therein, a CPU (Central Processing Unit) for executing a program filed in the above non-volatile storage device, and a primary storage device.

The use control means 22, responding to an operation performed by the data user for the user input/output means 20, decrypts the encrypted confidential data filed in the data file means 23 by employing the decryption key, and presents the already-decrypted data (confidential data) to the data user via the user input/output means 20. Further, the use control means 22 downloads or receives the right certificate including the decryption key necessary for using the confidential data from the right management server 3, and files it in the certificate file means 24.

The data file means 23, which includes, for example, non-volatile storage devices such as a flash memory and a hard disc array, files the encrypted confidential data. Further, The data file means 23, according to an operation performed by the data user for the user input/output means 10, prepares a list of the encrypted confidential data filed therein, and presents it to the data administrator via the user input/output means 20 in some cases, or transmits the encrypted confidential data to the appliances such as other mobile terminals in some cases.

The certificate file means 24, which includes, for example, non-volatile storage devices such as a flash memory and a hard disc array, files the right certificate. Further, the certificate file means 24, responding to a request for outputting the right certificate made by the use control means 22 with the confidential data ID designated, outputs the right certificate corresponding to the above confidential data ID to the use control means 22.

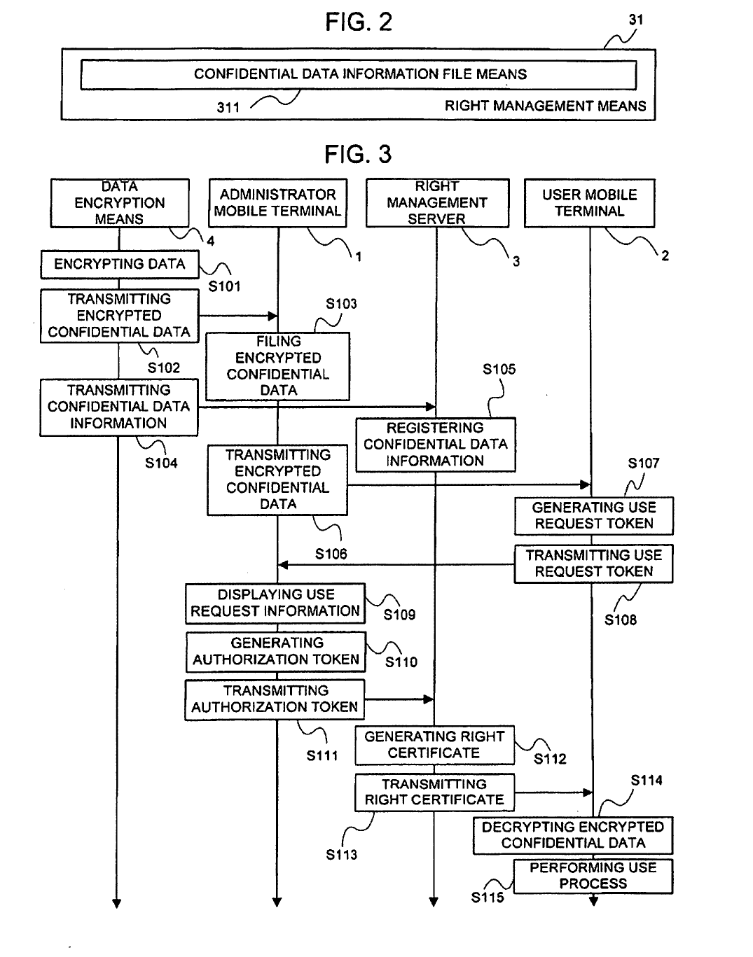

The right management server 3 includes right management means (decryption key transmission means) 31. FIG. 2 is an explanatory view for explaining a configuration of the right management means 31. The right management means 31 includes confidential data information file means (database) 311. The confidential data information file means 311 is, for example, a database. The confidential data information file means 311 files right data including the decryption key of the encrypted confidential data, the confidential data ID, the data administrator ID for identifying the administrator of the confidential data, and right definition information indicating a use right of the data user.

Additionally, the right definition information is, for example, a list of the use methods of the confidential data that the data user is permitted to use.

Further, the right management means 31 generates the right certificate including the confidential data ID, the data user ID, the right definition information, and the decryption key, and transmits it to the user mobile terminal 2. Additionally, the right management means 31, when receiving a request for transmitting the right certificate from the use control means 22 of the user mobile terminal 2, may transmit the right certificate to the user mobile terminal 2.

The data encryption means 4 is, for example, a computer including a non-volatile storage device having an encryption program etc. filed therein, a CPU for executing a program filed in the above non-volatile storage device, and a primary storage device.

The date encryption means 4 includes encrypted data generation means 41 for generating the encrypted confidential data obtained by encrypting the confidential data, the decryption key for decrypting the encrypted confidential data, and a confidential data ID for identifying the encrypted confidential data, right definition means 42 for generating the right definition information, and information transmission means 43 for generating confidential data information including the confidential data ID, the decryption key, the data administrator ID, and the right definition information, and transmitting it to the right management server 3, and data output means 44 for outputting the encrypted confidential data.

Additionally, the data output means 44 could be, for example, a slot of a portable memory devices such as an SD memory card and a USB key, and could be communication means for making infrared-ray communication or communication via Bluetooth, and Internet with the data file means 12 of the administrator mobile terminal 1.

Additionally, the encrypted data generation means 41 may include a random number generator, thereby to generate a random decryption key in some cases, may acquire the decryption key from other reliable key generation servers etc. in some cases, or may generate or acquire the decryption key with other methods in some cases.

Additionally, the encrypted data generation means 41 generates the confidential data ID indicating the generated encrypted confidential data by employing the method in which uniqueness of the confidential data ID is assured. Specifically, for example, Universal Unique Identifier (UUID) described in RFC (Request For Comment)-4122 (Reference document 1) is employed. And, the encrypted data generation means 41 generates the encrypted confidential data including the portion in which the confidential data has been encrypted and the portion indicating the confidential data ID.

[Reference Document 1]

P. Leach et al. (two persons), “RFC-4122-A Universally Unique IDentifier (UUID) URN Namespace”, [online], July, 2005, Network Working Group, [Retrieval, Aug. 3, 2006], Internet <URL:http://rfc.sunsite.dk/rfc/rfc4122.html>

Further, the right definition means 42 may generate the right definition information corresponding to each piece of the generated encrypted confidential data in some cases, or may generate the right definition information corresponding to the data user that is permitted to use the confidential data.

Additionally, the user mobile terminal 2 has a data use program installed thereinto for causing a computer to execute a decryption process of employing a decryption key for decrypting encrypted data, being data that has been encrypted, thereby to decrypt the encrypted data, and a use request process of generating a use request token for requesting permission of a use of the data, which includes encrypted data identification information for identifying the encrypted token, transmitting it by near-distance wireless communication or causing display means to display the use request data, and requesting an administrator of the encrypted data to use the data.

Further, the administrator mobile terminal 1 has a data management program installed thereinto for causing a computer to execute a data acquisition process of acquiring a use request token including encrypted data identification information for identifying encrypted data and user identification information indicating a user of the data, which indicates a request for permitting a use of the data, from a data-use appliance for using data, and an input/output process of displaying the encrypted data identification information and the user identification information being included in the use request token acquired in the data acquisition process in display means, and causing a user to input an instruction indicating whether or not the data-use appliance is permitted to use the data into input means.

Next, an operation of the data use managing system of the first embodiment will be explained by making a reference to the accompanied drawings. FIG. 3 is a sequence block for explaining an operation in the first embodiment of the data use management system.

Additionally, in this embodiment, the data administrator employs the administrator mobile terminal 1 and the data encryption means 4, the data user employs the user mobile terminal 2, and a right management service enterpriser operates the right management server 3.

The encrypted data generation means 41 of the data encryption means 4, according to a data administrator's instruction, generates the encrypted confidential data obtained by encrypting the confidential data that is a target of use management, the decryption key for decrypting the above encrypted confidential data, and the confidential data ID for identifying the above encrypted confidential data (step S101). The right definition means 42 of the data encryption means 4, according to a data administrator's instruction, generates the right definition information.

The information transmission means 43 of the data encryption means 4 transmits the generated encrypted confidential data to the administrator mobile terminal 1 (step S102). The administrator mobile terminal 1 files the received encrypted confidential data in the data file means 12 (step S103).

The information transmission means 43 of the data encryption means 4 transmits the confidential data information including the confidential data ID, the decryption key, the data administrator ID, and the right definition information to the right management server 3 (step S104). The right management server 3 having received the confidential data information registers a set of the confidential data ID, the decryption key, the data administrator ID, and the right definition information described in the confidential data information as right data into one record of the database (step S105).

The right transfer means 11 of the administrator mobile terminal 1, according to a data administrator's instruction inputted into the user input/output means 10, transmits the encrypted confidential data filed in the data file means 12 to the user mobile terminal 2 (step S106). Specifically, the right transfer means 11 of the administrator mobile terminal 1, for example, may make a push delivery (multicast or broadcast) to specific or non-specific user motile terminals 2 via the communication network in some cases, or may cause the user mobile terminal 2 to download the encrypted confidential information via an optional file server. Further, when the data file means 12 of the administrator mobile terminal 1 and the data file means 23 of the user mobile terminal 2 have been realized with the portable memory devices such as the SD memory card and the USB key, the data administrator of the administrator mobile terminal 1 may deliver the above device having the encrypted confidential data filed therein to the data user of the user mobile terminal 2.

The right transfer means 21 of the user mobile terminal 2 files the encrypted confidential data transmitted by the right transfer means 11 of the administrator mobile terminal 1 in the data file means 23.

An operation in the case that the data user uses the confidential data will be explained.

The right transfer means 21 of the user mobile terminal 2 generates a use request token, which includes the confidential data ID indicating the encrypted confidential data filed in the data file means 23 and the data user ID, and yet indicates a request for using the above encrypted confidential data (step S107), and transmits the generated use request token to the administrator mobile terminal 1 of the data administrator (step S108).

Herein, the transmission of the use request token is carried out with the near-distance wireless communication such as the infrared-ray communication and Bluetooth in order to cause the data user to perform an authorization process, which is later described, in a face-to-face meeting with the data administrator. Additionally, the right transfer means 21 of the user mobile terminal 2 may cause the user input/output means 20 to display an image in which the use request token has been two-dimensionally bar-coded, and cause a device for reading off a two-dimension barcode, which the administrator mobile terminal 1 includes, to read off the above image.

The right transfer means 11 of the administrator mobile terminal 1 having acquired the use request token causes the user input/output means 10 to display the use request information (step S109), and causes the data administrator to perform an authorization process. Additionally, the use request information includes the confidential data ID and the data user ID that are included in the use request token. Further, the so-called authorization process is a process in which the data administrator inputs an instruction into the user input/output means 10 of the administrator mobile terminal 1 in order to authorize the data user to use the confidential data.

When an instruction for authorizing the data user to use the confidential data has been inputted into the user input/output means 10 by the data administrator, the right transfer means 11 of the administrator mobile terminal 1 generates an authorization token including the confidential data ID and data user ID that are included in the use request token, and the data administrator ID (step S110), and transmits the generated authorization token to the right management server 3 (step S111). Additionally, when the data administrator does not authorize the data user to use the confidential data, the administrator mobile terminal 1 finishes the process.

The right management means 31 of the right management server 3 having received the authorization token scans (makes a reference to) the record of the confidential data information file means 311 (database), and as a result, when the record that coincides with a set of the confidential data ID and the data administrator ID being included in the received authorization token exists, the right management means 31 makes a reference to the right definition information registered into the above record, and generates a right certificate in which the confidential data ID, the data user ID, the right definition information, and the decryption key have been described (step S112).

The right management means 31 of the right management server 3 transmits the generated right certificate to the use control means 22 of the user mobile terminal 2 (step S113). Additionally, the right management means 31 of the right management server 3 may not execute the step S112 (generation of the right certificate) and the step S113 (transmission of the right certificate) in succession. For example, after the right management means 31 of the right management server 3 executes the step S112 (generation of the right certificate), the use control means 22 of the user mobile terminal 2 may request the right management means 31 of the right management server 3 to transmit the right certificate, thereby to download the right certificate.

The use control means 22 of the user mobile terminal 2 having received the right certificate files the received right certificate in the certificate file means 24, decrypts the encrypted confidential data filed in the data file means 23 (step S114) by employing the decryption key described in the received right certificate, and executes a process of using the decrypted confidential data responding to an operation being inputted into the user input/output means 20 (step S115).

Herein, the use process of the confidential data that is performed by the use control means 22 of the user mobile terminal 2 is limited to the use method permitted by the right definition information described in the right certificate. For example, when an operation ID [play] is pre-assigned to the reproduction operation, and only [play] is permitted by the right definition information, the use control means 22 accepts only the operation equivalent to [play] (for example, display of the confidential data via the user input/output means 20), and rejects all other operations.

In this embodiment, in order for the data user to use the confidential data, the administrator mobile terminal 1 that the data administrator employs has to receive the use request token being transmitted from the user mobile terminal 2 by the near-by communication (near-distance wireless communication etc.). This makes it possible to realize the use management of the confidential data with a face-to-face meeting between the data administrator and the data user.

Thus, for example, when a certain maintenance worker (data user) handles customer data that should be protected as a confidential data with a certain customer (data administrator) in identical premises, the maintenance worker has to be authorized to use the customer data in a face-to-face meeting with the above customer, so an illegal use such that the maintenance worker uses the above customer data outside the premises can be prevented beforehand.

Further, the confidential data filed in the user mobile terminal 2 that the maintenance worker (data user) carries about with him/her has been pre-encrypted, so the customer data can be prevented from leaking to the outside even though he/her losses his/her user mobile terminal 2, or it is stolen during migration.

Additionally, information indicating conditions of the validity period of the right certificate is adapted to be included in the right definition information, and as a result, the use control means 22 of the user mobile terminal 2 may confirm the validity period of the right certificate that the right definition information indicates whenever occasions arise. Specifically, for example, the conditions associated with the validity period is previously described in the right certificate that is issued to the data user in such a manner that the certificate is revoked in a short time such as several minutes, and the use control means 22 of the user mobile terminal 2 that the data user employs may confirm the validity period of the right certificate whenever occasions arise.

Making such a configuration enables a purchaser (data administrator) of amusement contents (confidential data) to temporarily share amusement contents (confidential data) that a purchaser has with a friend etc. (data user) existing within a neighboring space.

Additionally, the data user ID has been stored in the non-volatile memories such as SIM (Subscriber Identity Module) and USIM (Universal SIM) that the user mobile terminal 2 includes.

Further, the data administrator ID has been stored in the non-volatile memories such as SIM and USIM (Universal SIM) that the administrator mobile terminal 1 includes. Further, the data encryption means 4 pre-stores the data administrator ID.

Additionally, instead of making a configuration so that the data encryption means 4 includes the right definition means 42, the right management server 3 may include the right definition means 42, and the right definition means 42 of the right management server 3, which, according to a data administrator's instruction inputted into a computer for realizing the data encryption means 4, has been connected to the above computer via the communication network such as Internet may generate the right definition information.

### Embodiment 2

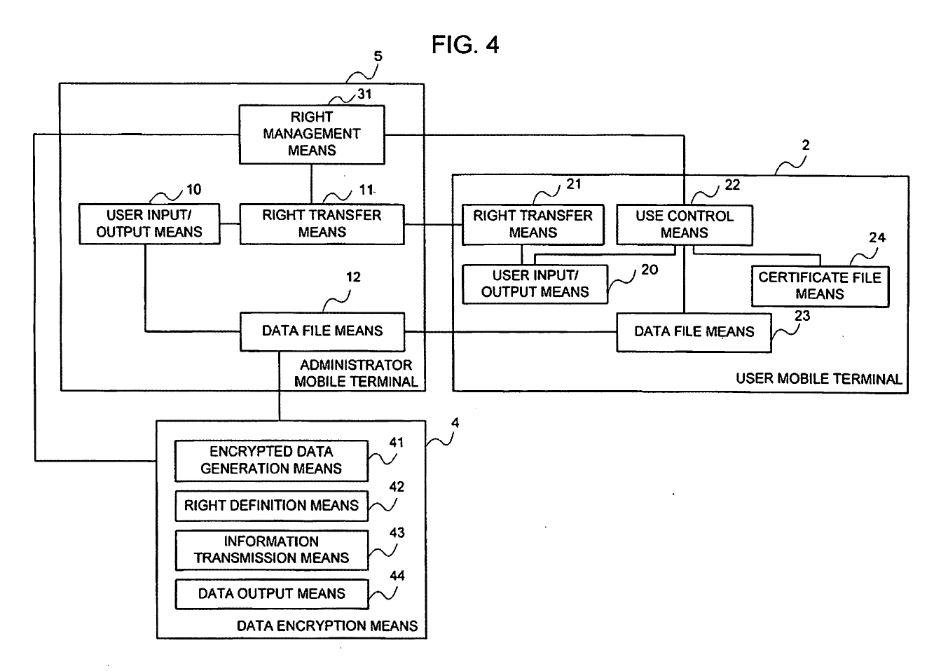

Next, the second embodiment of the data use managing system of the present invention will be explained by making a reference to the accompanied drawings. FIG. 4 is a block diagram illustrating a configuration example of the second embodiment of the data use managing system of the present invention.

The data use managing system shown in FIG. 4 includes an administrator mobile terminal 5 instead of the administrator mobile terminal 1 and the right management server 3 of the data use managing system of the first embodiment shown in FIG. 1. Components other than it are similar to that of each component of the data use managing system of the first embodiment, so a code identical to that of FIG. 1 is affixed and its explanation is omitted.

While the administrator mobile terminal 5 includes each component of the administrator mobile terminal 1 of the first embodiment shown in FIG. 1, it differs from the administrator mobile terminal 1 of the first embodiment shown in FIG. 1 in a point of including right management means 31 connected to the right transfer means 11 by a local wiring.

While an operation of each component is similar to that of the first embodiment, the data administrator plays a part of the right management service enterpriser in the first embodiment concurrently with its original part in this embodiment.

This embodiment exhibits an effect that the data use managing system is easily constructed and introduced because the right management server 3 becomes useless.

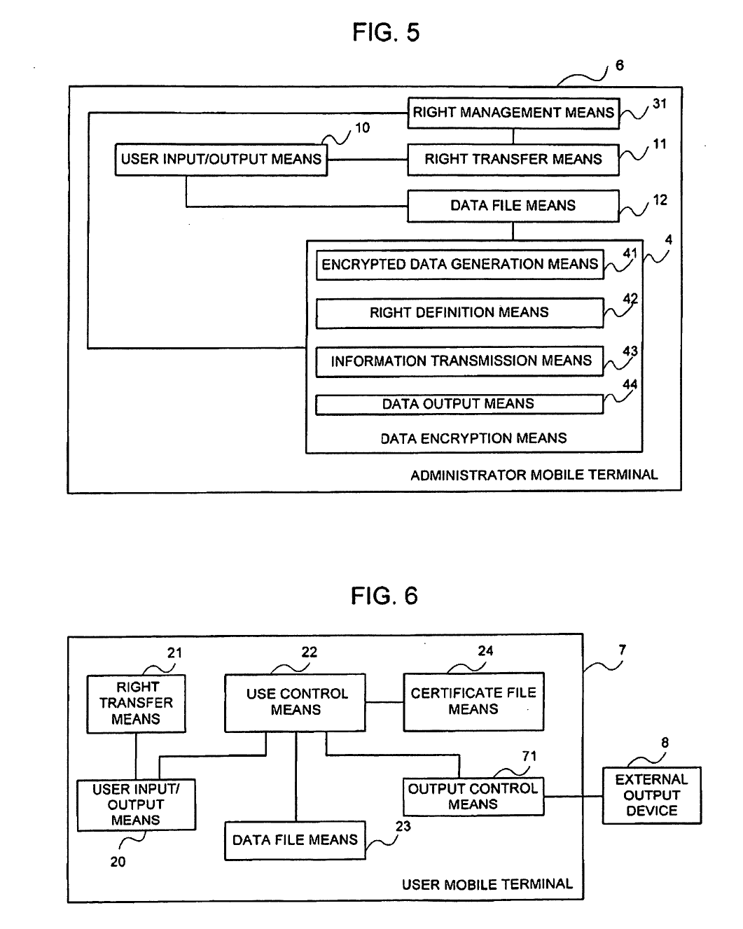

Additionally, the administrator mobile terminal 5 and the data encryption means 4 may be integrated. FIG. 5 is a block diagram illustrating a configuration example of the administrator mobile terminal 6 in which the administrator mobile terminal 5 and the data encryption means 4 have been integrated.

Making such a configuration enables the data administrator to consistently carry out generation, distribution, and use management of the confidential data by employing the highly functionalized mobile terminals such a PDA and a note-type personal computer as the administrator mobile terminal 6.

### Embodiment 3

Next, the third embodiment of the data use managing system of the present invention will be explained. A configuration of the third embodiment of the data use managing system of the present invention includes a user mobile terminal 7 connected to an external output device 8 instead of the user mobile terminal 2 of the data use managing system of the first embodiment shown in FIG. 1. Components other than it are similar to that of each component of the data use managing system in the first embodiment, so a code identical to that of FIG. 1 is affixed and its explanation is omitted. FIG. 6 is a block diagram illustrating a configuration example of the user mobile terminal 7 in the third embodiment of the data use managing system of the present invention.

The user mobile terminal 7 shown in FIG. 6 includes output control means 71 connected to the use control means 22 besides the components of the user mobile terminal 2 of the first embodiment shown in FIG. 1. Further, the external output device 8 has been connected to the output control means 71.

When the output device instruction information and the decrypted confidential data have been inputted from the use control means 22, the output control means 71 transmits the confidential data to the external output device 8 designated by the output device instruction information.

The external output device 8 is a data output device, for example, a projector, an LCD, a printer, a speaker, etc.

Next, an operation of the data use managing system of the third embodiment will be explained by making a reference to the accompanied drawings. Additionally, an operation of each component that is performed until the right certificate is transmitted to the user mobile terminal 7 in this embodiment is similar to that of each component ranging from the step S101 to the step S113 of the first embodiment shown in FIG. 3, so its explanation is omitted.

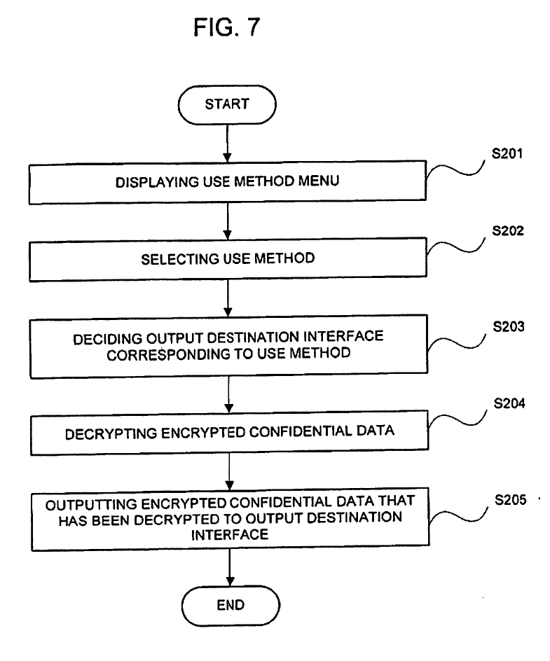

FIG. 7 is a flowchart for explaining an operation of outputting the confidential data to the external output device 8. Additionally, in this example, it is assumed that permission of using the confidential data for [play] and [print] is described in the right certificate. Further, it is assumed that the use method [play] corresponds to [display by a terminal] and the use method [print] to [print by a printer].

The use control means 22 of the user mobile terminal 7 having received the right certificate files the received right certificate in the certificate file means 24. And, the use control means 22, based upon right definition information described in the right certificate, causes the user input/output means 20 to display a menu screen (step S201), and causes the data user to select the method of using the confidential data (step S202).

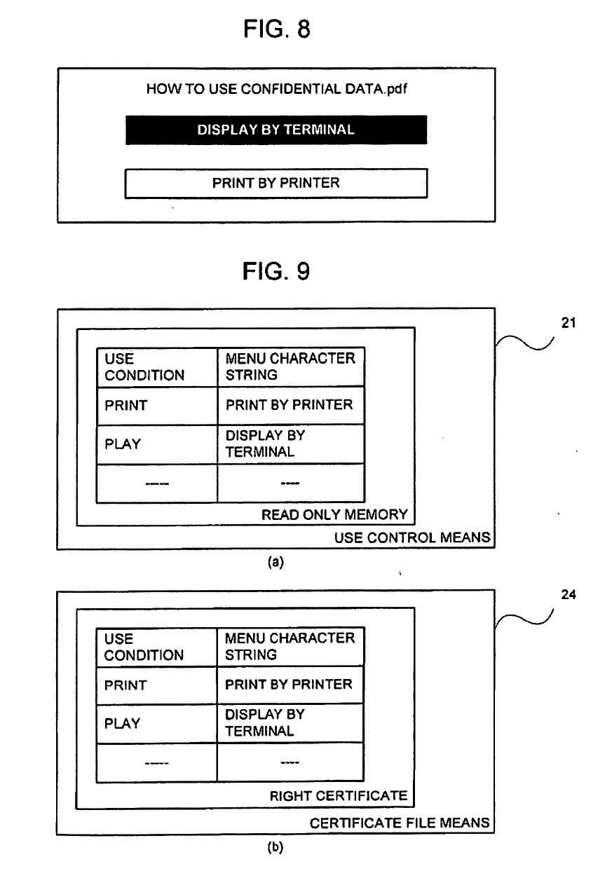

FIG. 8 is an explanatory view illustrating one example of the menu screen that is displayed by the user input/output means 20. In an example shown in FIG. 8, the user input/output means 20 causes the data user to select whether the confidential data is displayed in the terminal, or is printed by the printer by employing the menu screen that the user input/output means 20 displays.

Additionally, a table for causing the use method and a character string being displayed in the menu screen to correspond to each other may be pre-filed in a read only memory that the use control means 22 includes, or may be described in the right certificate. FIG. 9(a) is an explanatory view illustrating one example of a table for causing the use method filed in the read only memory that the use control means 22 includes, and the character string being displayed in the menu screen to correspond to each other. FIG. 9(b) is an explanatory view illustrating one example of a table for causing the use method described in the right certificate and the character string being displayed in the menu screen to correspond to each other. An example shown in FIG. 9(a) and FIG. 9(b) shows that the use method [print] corresponds to the menu character string [print by a printer], and the use method [play] corresponds to the menu character string [display by a terminal].

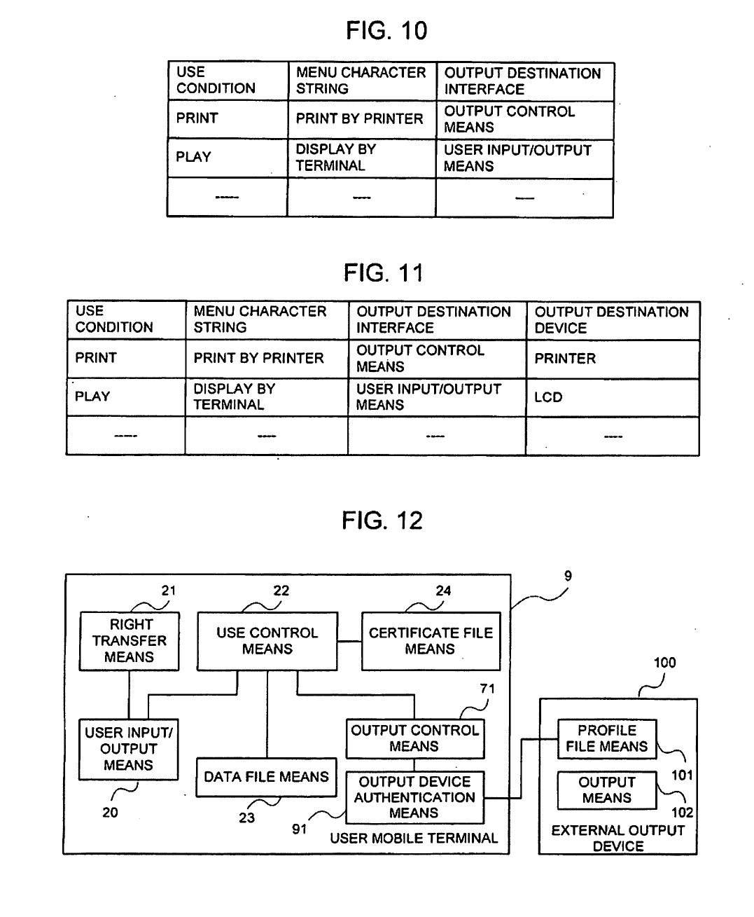

Additionally, the use control means 22 includes a non-volatile memory having a correspondence table stored therein of the use method, the character string being displayed in the menu screen, and an output destination interface. FIG. 10 is an explanatory view illustrating one example of a correspondence table of the use method, the character string being displayed in the menu screen, and the output destination interface. An example shown in FIG. 10 shows that the use method [print] corresponds to the menu character string [print by a printer] and the output destination interface [output control means], and the use method [play] to the menu character string [display by a terminal] and the output destination interface [user input/output means].

The use control means 22 decides whether the output destination interface that corresponds to the use method selected by the data user is the user input/output means 20 or the output control means 71 by making a reference to the correspondence table of the use method, the character string being displayed in the menu screen, and the output destination interface (step S203).

For example, in the menu screen shown in FIG. 8, when a [display by a terminal] screen has been selected, the use control means 22 decides that the output destination interface is the user input/output means 20 by making a reference to the correspondence table stored by the non-volatile memory. Further, in the menu screen shown in FIG. 8, when a [print by a printer] screen has been selected, the use control means 22 decides that the output destination interface is the output control means 71 by making a reference to the correspondence table stored by the non-volatile memory.

The use control means 22 outputs a plaintext version of the confidential data (the confidential data that has not been encrypted) to the output destination interface decided in the step S203 (step S205) while decrypting the encrypted confidential data by employing the decryption key described in the right certificate (step S204).

When the output destination interface is the user input/output means 20, the user input/output means 20 displays the inputted plaintext version of the confidential data, and presents it to the data user. When the output destination interface is the output control means 71, the output control means 71 outputs the plaintext version of the confidential data to the appropriate external output device 8.

Additionally, when the external output devices 8 exist in plural, the use control means 22 may include the non-volatile memory having the correspondence table stored therein of the use method, the character string being displayed in the menu screen, the output destination interface, and the output destination device. FIG. 11 is an explanatory view illustrating one example of a correspondence table of the use method, the character string being displayed in the menu screen, the output destination interface, and the output destination device. An example shown in FIG. 11 shows that the use method [print] corresponds to the menu character string [print by a printer], the output destination interface [output control means], and the output destination device [printer], and the use method [play] to the menu character string [display by a terminal], the output destination interface [user input/output means], and the output destination device [LCD].

This embodiment makes it possible to enhance safetiness of the confidential data all the more because data administrator's authorization is required not only in the case of using the confidential data by employing the user mobile terminal 7, but also in the case of using the confidential data by employing the external output device 8.

### Embodiment 4

Next, the fourth embodiment of the data use managing system of the present invention will be explained. The data use managing system of the fourth embodiment includes a user mobile terminal 9 connected to an external output device 100 instead of the user mobile terminal 7 of the third embodiment.

FIG. 12 is a block diagram illustrating a configuration example of the user mobile terminal 9 and the external output device 100 of the fourth embodiment. In an example shown in FIG. 12, the user mobile terminal 9 differs from the user mobile terminal 7 of the third embodiment in a point of including output device authentication means (authentication means) 91, and the external output device 100 differs from the external output device 8 of the third embodiment in a point of including profile file means 101 and output means 102.

Components other than it are similar to each component in the first embodiment, and each component in the third embodiment, so a code identical to that of FIG. 1 or FIG. 6 is affixed and its explanation is omitted.

The external output device 100 includes the profile file means 101 and the output means 102. The profile file means 101, which includes storage means (for example, non-volatile memory) having profile information of the external output device 100 filed therein, transmits the profile information filed in the storage means to the user mobile terminal 9 responding to the request for transmitting the profile received from the user mobile terminal 9. Additionally, the profile information (authentication information) includes an appliance ID for specifying the appliance (external output device 100), and attribution information indicating a function etc. that the appliance has. The attribution information includes, for example, appliance classifications such as a printer and a display, a flag indicating whether or not the appliance includes a storage capable of permanently or temporarily filing data, and further a flag indicating whether or not the appliance has a function of setting up a connection to other appliances.

The output means 102 is an output device for outputting the confidential data inputted from the user mobile terminal 9, and, for example, print means including a print drum, and a LCD.

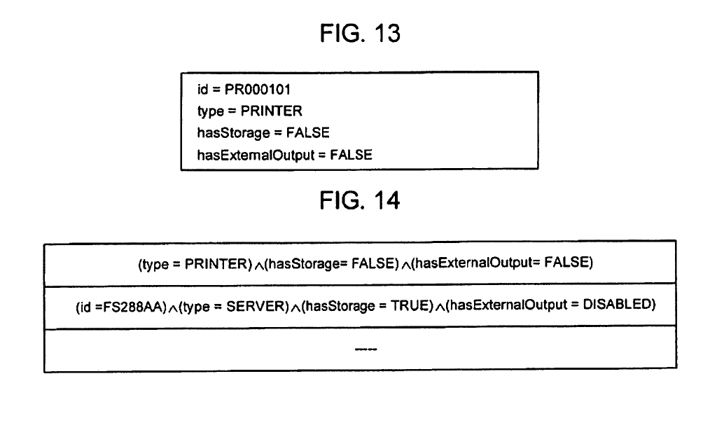

FIG. 13 is an explanatory view illustrating one example of the profile information stored by the profile file means 101 of the external output device 100. An example shown in FIG. 13 shows that the appliance ID (the attribute name is [id]) for identifying the external output device 100 is [PR000101] (attribute value), and the appliance classification of the external output device 100 (the attribute name is [type]) is [PRINTER] (attribute value).

Further, an example shown in FIG. 13 shows by flag the fact that the external output device 100 does not include the file means for permanently or temporarily filing data (that is, the attribute value of the attribute name [hasStorage] is [FALSE]), and shows by the flag the fact that the external output device 100 has not a function of setting up a connection to other appliances (that is, the attribute value of the attribute name [hasExternalOutput] is [FALSE]).

The output device authentication means 91 of the user mobile terminal 9, responding to an authentication result that is obtained by collating the profile information received from the external output device 100 with an authentication standard (authentication rule), transmits the confidential data outputted by the output control device 71 to the external output device 100. Additionally, the output device authentication means 91 includes the storage means (for example, the non-volatile memory) having the authentication rule pre-stored therein.

FIG. 14 is an explanatory view illustrating an example of the authentication rule. In the authentication rule shown n FIG. 14, phrases associated with a set of the attribution name and the attribution value are expressed. Additionally, the attribution name may include the appliance ID.

An example shown in the first line of FIG. 14 shows that the profile information, which shows by a flag the fact that the appliance classification of the output device (the attribute name is [type]) is [PRINTER] (the attribute value), and the output device does not include the file means for permanently or temporarily filing data (that is, the attribute value of the attribute name [hasStorage] is [FALSE]), and shows by flag the fact that the output device has not a function of setting up a connection to other appliances (that is, the attribute value of the attribute name [hasExternalOutput] is [FALSE]), meets the authentication rule.

Next, an operation of the data use managing system of the fourth embodiment will be explained by making a reference to the accompanied drawings. Additionally, an operation of each component that is performed until the right certificate is transmitted to the user mobile terminal 9 in this embodiment is similar to that of each component ranging from the step S101 to the step S113 of the first embodiment shown in FIG. 3, so its explanation is omitted.

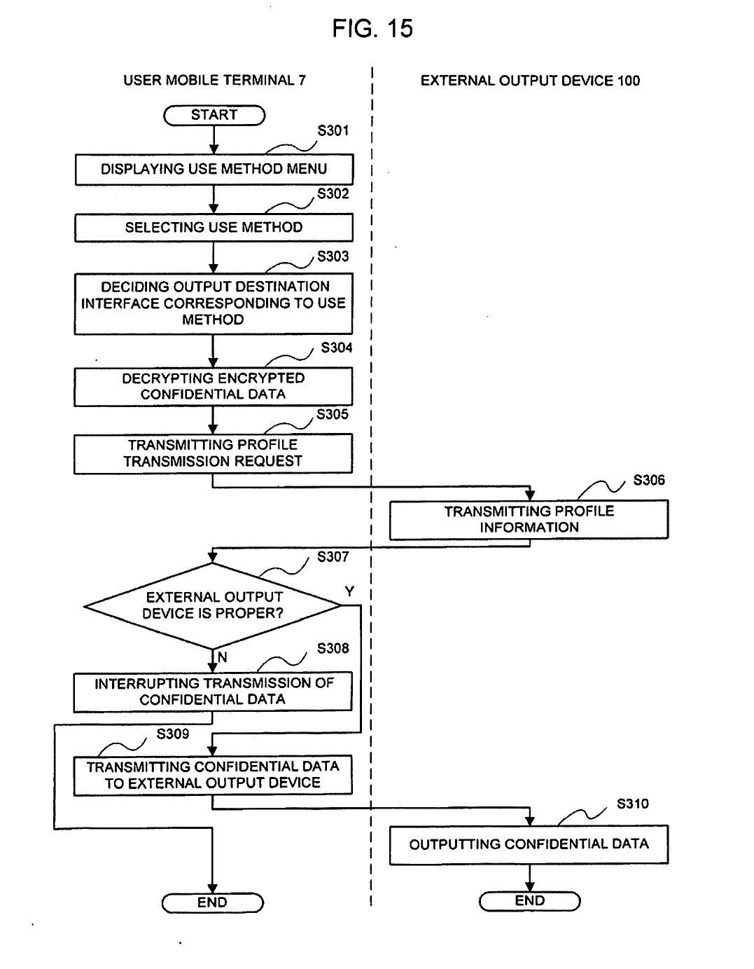

FIG. 15 is a flowchart for explaining an operation of outputting the confidential data to the external output device 100. Additionally, in this example, it is assumed that the external output device 100 is a printer, and permission for using the confidential data for [play] and [print] is described in the right, certificate. Further, it is assumed that the use method [play] corresponds to [display by a terminal], and the use method [print) to (print by a printer].

The use control means 22 of the user mobile terminal 9 having received the right certificate files the received the right certificate in the certificate file means 24. And, the use control means 22 reads off the right definition information described in the right certificate, causes the user input/output means 20 to display the menu screen (step S301), and causes the data user to select the method of using the confidential data (step S302).

The use control means 22 decides whether the output destination interface that corresponds to the use method selected by the data user is the user input/output means 20 or the output control means 71 by making a reference to a correspondence table of the use method, the character string being displayed in the menu screen, and the output destination interface (step S303). In this example, it is assumed that the output destination interface has been decided to be the output control means 71.

The use control means 22 outputs a plaintext version of the confidential data to the output device authentication means 91 via the output control means 71 while decrypting the encrypted confidential data by employing the decryption key described in the right certificate (step S304).

The output device authentication means 91 transmits a request for transmitting a profile to the external output device 100 (step S305).

The external output device 100 having received the request for transmitting a profile transmits the profile information pre-filed in the profile file means 101 to the output device authentication means 91 (step S306).

The output device authentication means 91 receives the profile information from profile file means 101. And, the output device authentication means 91, based upon the appliance ID and the attribute information being included in the profile information, and the authentication rule stored by the storage means, determines whether or not the external output device 100 is suitable as an output device (step S307).

When the output device authentication means 91 has determined that the external output device 100 is not suitable for obtaining the confidential data (N of the step S307), it interrupts transmission of the inputted confidential data to the external output device 100 (step S308).

When the output device authentication means 91 has determined that the external output device 100 is suitable (Y of the step S307), it transmits the confidential data to the external output device 100 (step 5309).

Additionally, the output device authentication means 91 may establish an encryption communication path such as Secure Socket Layer (SSL) with the external output device 100 in order to prevent the confidential data from being wiretapped.

The output means 102 of the external output device 100 having received the confidential data outputs the confidential data (step S310).

This embodiment makes it possible to previously prevent the plaintext version of the confidential data from leaking, for example, to the personal computer with a record function, and other mobile terminals because the output device authentication means 91 performs an authentication operation as to whether or not the external output device 100 is suitable as an output device of the confidential information based upon the profile information.

### Embodiment 5

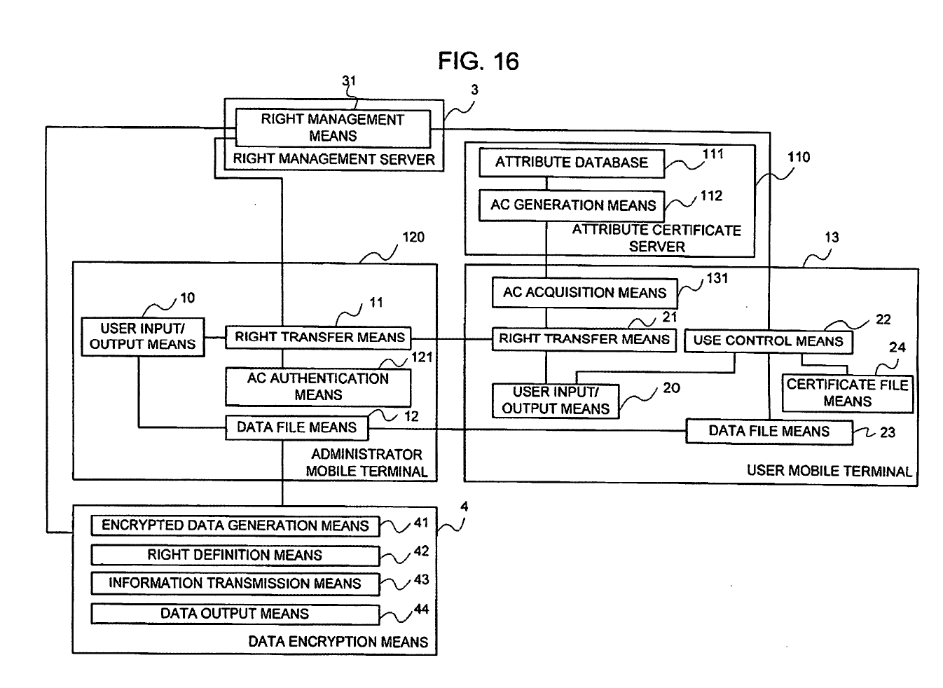

Next, the fifth embodiment of the data use managing system of the present invention will be explained by making a reference to the accompanied drawings. FIG. 16 is a block diagram illustrating a configuration example of the fifth embodiment of the data use managing system of the present invention.

The data use managing system shown in FIG. 16 includes an attribute certificate (AC) server 110, an administrator mobile terminal 120 instead of the administrator mobile terminal 1 of the data use managing system of the first embodiment shown in FIG. 1, and a user mobile terminal 13 instead of the user mobile terminal 2 of the data use managing system of the first embodiment shown in FIG. 1. Components other than it are similar to each component of the data use managing system of the first embodiment, so a code identical to that of FIG. 1 is affixed and its explanation is omitted.

As shown in FIG. 16, the attribute certificate server 110 includes an attribute database 111 and AC generation means (attribute certificate generation means) 112.

One set of the attribute name indicating a position of the data user and the attribute value, or more has been stored correspondingly to the data user ID in the attribute database 111, and when the data user ID has been inputted from the AC generation means 112, a list of a set of the attribute name and the attribute value that corresponds to the inputted data user ID is outputted.

When the AC generation means 112 has received the data user ID from the mobile terminal 13 of the data user, it acquires a list of a set of the attribute name and the attribute value that corresponds to the received data user ID, describes the acquired list from the attribute database 111, generates the attribute certificate indicating the attribute of the data user, and transmits it to the user mobile terminal 13.

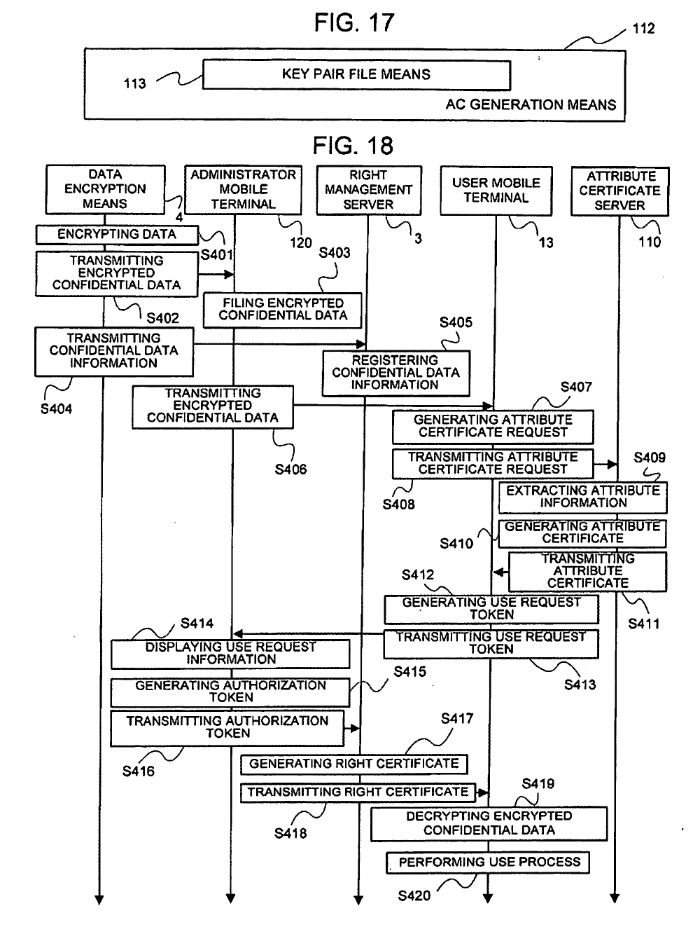

Additionally, the AC generation means 112 includes key pair file means 113. FIG. 17 is an explanatory view illustrating one configuration example of the AC generation means 112. A set of a public key and a secret key of an attribute authority, being a server or an enterpriser for digital-signing the attribute certificate, has been filed in the key pair file means 113.

The user mobile terminal 13 includes an AC acquisition means 131. The AC acquisition means 131 outputs the attribute certificate to the right transfer means 21 at the time that the right transfer means 21 generates a use request token. The right transfer means 21 generates the use request token including the attribute certificate, and transmits it to an administrator mobile terminal 120.

The administrator mobile terminal 120 includes an AC authentication means 121. The AC authentication means 121 extracts a list of a set of the attribute name and the attribute value described in the attribute certificate that is included in the use request token received from the user mobile terminal 13 being employed by the data user, and transmits it to the right transfer means 11.

Next, an operation of the data use managing system of the fifth embodiment will be explained by making a reference to the accompanied drawings. FIG. 18 is a sequence block for explaining an operation in the fifth embodiment of the data use managing system.

The encrypted data generation means 41 of the data encryption means 4, according to a data administrator's instruction, generates the encrypted confidential data obtained by encrypting the confidential data that is a target of use management, the decryption key for decrypting the above encrypted confidential data, and the confidential data ID for identifying the above encrypted confidential data (step S401). The right definition means 42 of the data encryption means 4, according to a data administrator's instruction, generates right definition information.

The information transmission means 43 of the data encryption means 4 transmits the generated encrypted confidential data to the administrator mobile terminal 120 (step S402). The administrator mobile terminal 120 files the received encrypted confidential data in the data file means 12 (step S403).

The information transmission means 43 of the data encryption means 4 transmits the confidential data information including the confidential data ID, the decryption key, the data administrator ID, and the right definition information to the right management server 3 (step S404). The right management server 3 having received the confidential data information registers a set of the confidential data ID, the decryption key, the data administrator ID, and the right definition information described in the confidential data information as right data into one record of the database (step S405).

The right transfer means 11 of the administrator mobile terminal 120, according to a data administrator's instruction inputted into the user input/output means 10, transmits the encrypted confidential data filed in the data file means 12 to the user mobile terminal 2 (step S406). The right transfer means 21 of the user mobile terminal 13 files the encrypted confidential data transmitted by the right transfer means 11 of the administrator mobile terminal 120 in the data file means 23.

The right transfer means 21 of the user mobile terminal 13 requests the AC acquisition means 131 to acquire the attribute certificate. The AC acquisition means 131, responding to the request by the right transfer means 21, generates an attribute certificate request indicating an request for transmitting the attribute certificate, which includes the data user ID (step S407).

The AC acquisition means 131 transmits the attribute certificate request to the right certificate server 110 that a predetermined attribute authority operates (step S408).

The AC generation means 112 of the attribute certificate server 110 having received the attribute certificate request extracts the data user ID included in the attribute certificate request, and requests an attribute database 111 to retrieve the attribute information (a sequence that is comprised of a set of the attribute name and the attribute value of which the set number is zero or more) with the extracted data user ID taken as a key.

The attribute database 111 retrieves and extracts the attribute information with the data user ID taken as a key (step S409), and outputs the extracted attribute information to the AC generation means 112. Additionally, a schema (structure) of the attribute database 111 could be an optional structure of the attribute authority on the assumption that the data user ID and each of a plurality of pieces of the attribute information can be registered and retrieved correspondingly to each other.

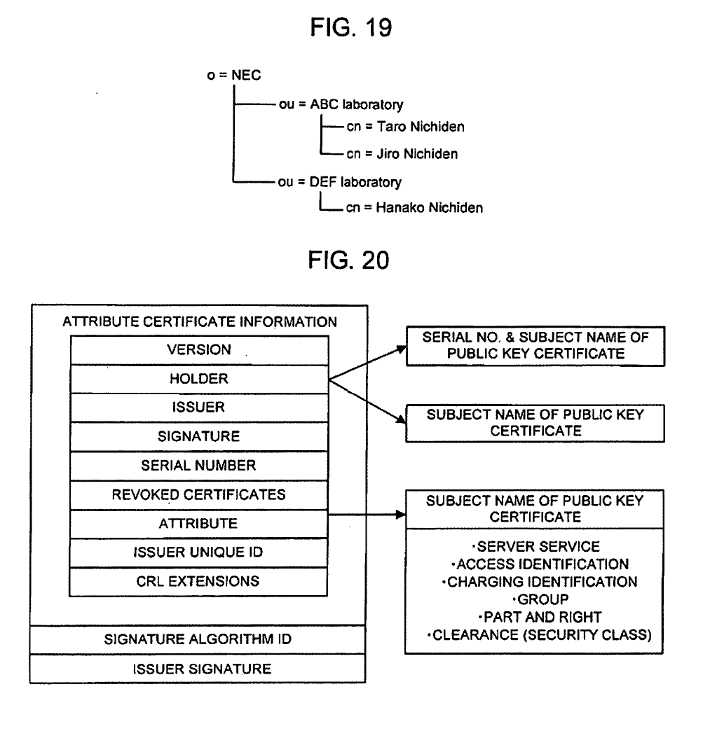

FIG. 19 is an explanatory view illustrating one example of a directory structure of the attribute database 111. The attribute database 111 handles a combination of an organization (o in FIG. 19), a department (ou in FIG. 19) and a name (cn in FIG. 19) of the data user as a data user ID. In an example of the directory structure shown in FIG. 19, the data user ID of Taro Nichiden is expressed by [cn=Taro Nichiden, ou=ABC laboratory, o=NEC], and is managed by employing the directory structure that is founded upon the organization and the department.

And, the AC generation means 112 having acquired the attribute information generates an attribute certificate in which data listed in the acquired attribute information has been digital-signed by employing a pair of a public key and a secret key of the attribute authority filed in the key pair file means 113 (step S410). Additionally, the attribute certificate format described in RFC-3281 (Reference document 2) is preferably employed as a format of the attribute certificate.

FIG. 20 is an explanatory view illustrating one example of a format of the attribute certificate. In an example shown in FIG. 20, the attribute authority (Issuer in FIG. 20) digital-signs the attribute certificate, thereby allowing the format supporting validity of the attribute of the data user (holder in FIG. 20) to be yielded. Additionally, in FIG. 20, a so-called subject name is equivalent to the data user ID. Additionally, FIG. 20 is described in Reference document 3.

Further, Security Assertion Markup Language (SAML), being a technical standard of OASIS (Organization for the Advancement of Structured Information Standards) described in Reference document 4 may be employed as format of the attribute certificate request and the attribute certificate.

[Reference Document 2]

S. Farrell et al. (one person), “RFC-3281-An Internet Attribute Certificate Profile for Authorization”, pp. 7-21, [online], April, 2002, Network Working Group, [Retrieval, Aug. 23, 2006], Internet <URL:http://rfc.sunsite.dk/rfc/rfc3281.html>

[Reference Document 3] “PKI Related Technology Document”, FIG. 9-3, [online], June, 2005, INFORMATION-TECHNOLOGY PROMOTION AGENCY, JAPAN, SECURITY CENTER, IT SECURITY TECHNOLOGY LABORATORY, [Retrieval, Aug. 23, 2006], Internet <URL:http://www.ipa.go.jp/security/pki/091.html>

[Reference Document 4]

John Kemp et al. (four persons), “Authentication Context for the OASIS Security Assertion Markup Language (SAML) V2,0”, [online], March, 2005, OASIS (Organization for the Advancement of Structured Information Standards), [Retrieval, Aug. 23, 2006], Internet (URL:http://www.japanpkiforum.jp/shiryou/SAML/saml-authn-context-2.0-os.pdf)

The AC generation means 112 transmits the generated attribute certificate to the user mobile terminal 13 (step S411).

The AC acquisition means 131 of the user mobile terminal 13 outputs the received attribute certificate to the right transfer means 21. The right transfer means 21 generates a use request token including the attribute certificate (step S412), and transmits it to the administrator mobile terminal 120 that the data administrator employs (step S413).

The right transfer means 11 of the administrator mobile terminal 120 having received the use request token extracts attribution information described in the attribute certificate via the AC authentication means 121. And, the right transfer means 11 causes the user input/output means 10 to display the extracted attribute information and the use request information including the confidential data ID and the data user ID (step S414), and causes the data administrator to perform an authorization process.

When an instruction for permitting the data user to use the confidential data has been inputted into the user input/output means 10 from the data administrator, the right transfer means 11 of the administrator mobile terminal 120 generates an authorization token (step S415), and transmits the generated authorization token to the right management server 3 (step S416).

The right management means 31 of the right management server 3 having received the authorization token scans the record of the confidential data information file means 311 (database), and as a result, when the record that coincides with a set of the confidential data ID and the data administrator ID being included in the received authorization token exists, the right management means 31 makes a reference to the right definition information registered into the above record, and generates a right certificate (step S417).

The right management server 3 transmits the generated right certificate to the use control means 22 of the user mobile terminal 13 (step S418).

The use control means 22 of the user mobile terminal 13 having received the right certificate files the received right certificate in the certificate file means 24, decrypts the encrypted confidential data filed in the data file means 23 by employing the decryption key described in the received right certificate (step S419), and executes a process of using the decrypted confidential data responding to an operation being inputted into the user input/output means 20 (step S420).

This embodiment enables the data administrator employing the administrator mobile terminal 120 to appropriately determine whether or not the data user properly uses the confidential data, thereby to authorize the data user to use the confidential data also in the case that it is difficult to authorize a use of the confidential data in a face-to-face meeting, for example, in the case of authorizing the former maintenance worker just retired to use the confidential data because the data administrator is caused to authenticate the authorization for using the confidential data by employing the attribute information indicating a position organization of the data user etc.

Additionally, the user mobile terminal 13 may include the output device authentication means 91, and may be connected to the external output device 100 including the profile file means 101. With such a configuration, an effect similar to that of the fourth embodiment can be obtained.

### Embodiment 6

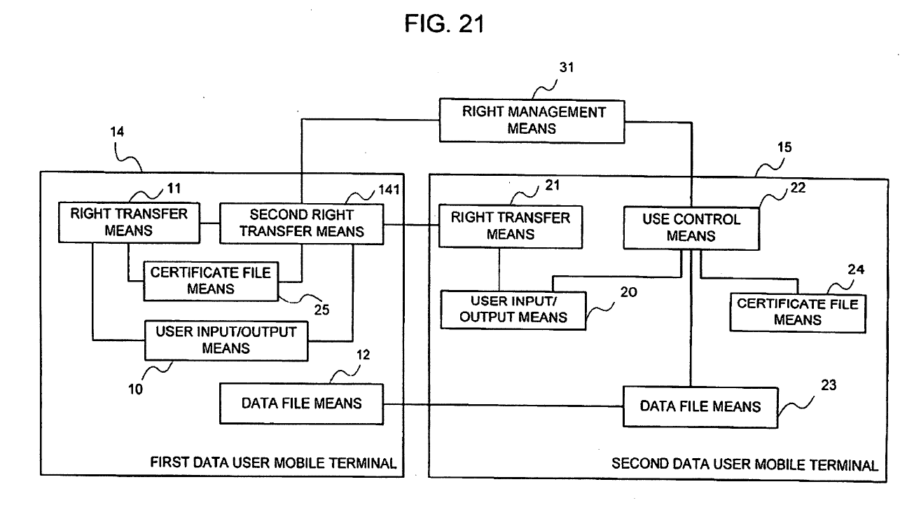

Next, the sixth embodiment of the data use managing system of the present invention will be explained by making a reference to the accompanied drawings. FIG. 21 is a block diagram illustrating a configuration example of the sixth embodiment of the data use managing system of the present invention.

The data use managing system of the sixth embodiment shown in FIG. 21 includes a first data user mobile terminal (data-use appliance) 14 that a first data user, which acquires the right certificate from the data administrator in the first place, employs instead of the administrator mobile terminal 1 of the first embodiment, and a second data user mobile terminal (right transferee appliance) 15 that a second data user, which acquires the right certificate from the first data user, employs instead of the user mobile terminal 2 of the first embodiment.

The first data user mobile terminal 14 includes a second right transfer means (right re-transfer means and data transmission means) 141 and certificate file means 25 besides components of the administrator mobile terminal 1 of the first embodiment.

When the second right transfer means 141 has acquired the use request token from the second data user mobile terminal 15 that the second data user employs, it causes the user input/output means 20 to present the acquired use request token to the data user, and causes the data user to performs a process of authorizing re-transfer of a right for using the confidential data. And, when the re-transfer of a right for using the confidential data has been authorized, the second right transfer means 141 further generates a re-transfer authorization token as re-transfer authorization data, and inputs (transmits) it into the right management means 31. Additionally, the re-transfer authorization token is information including the confidential data ID, the data user ID of the second data user, and the data user ID of the first data user.

Additionally, the right management means 31, similarly to the first embodiment, may be included in the right management server 3, or may be included in the first data user mobile terminal 14. The certificate file means 25 files the right certificate including the confidential data ID, the data user ID, the right definition information, and the decryption key.

The second data user mobile terminal 15 has a configuration similar to that of the user mobile terminal 2 of the first embodiment.

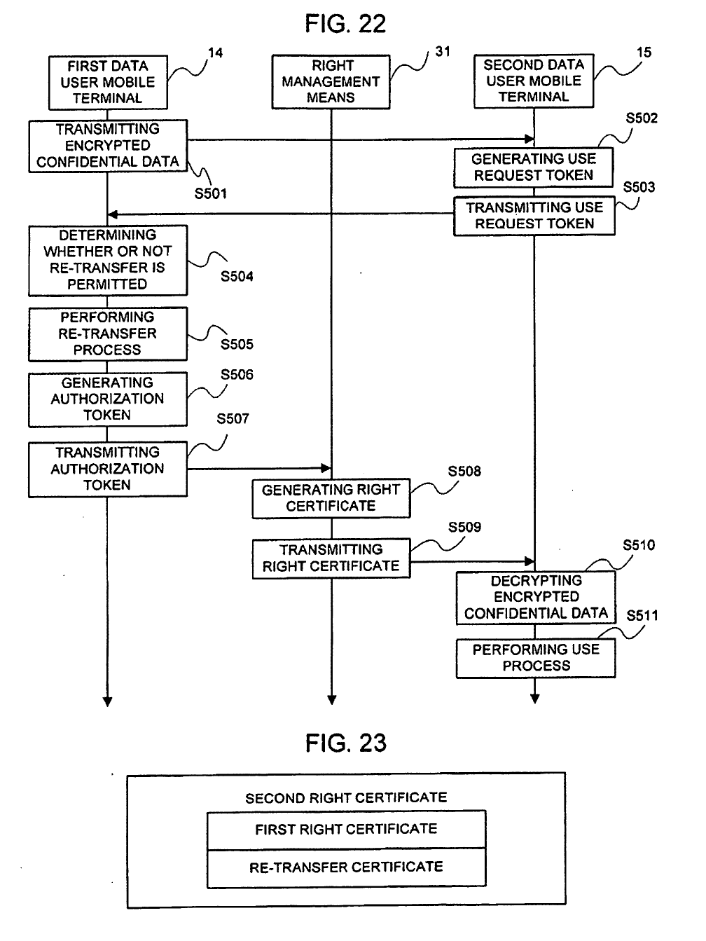

Next, an operation of the sixth embodiment of the present invention will be explained by making a reference to the accompanied drawings. FIG. 22 is a sequence block for explaining an operation of the sixth embodiment of the present invention.

Herein, it is assumed that the first data user has already acquired the right certificate that corresponds to the encrypted confidential data from the data administrator. That is, it is assumed that the encrypted confidential data has been filed in the data file means 23 of the first data user mobile terminal 14, and the right certificate that corresponds to the above encrypted confidential data has been filed in the certificate file means 24 of the first data user mobile terminal 14.

Additionally, in this embodiment, the right certificate includes re-transfer condition information indicating conditions under which a right for using the confidential data is re-transferred. The re-transfer condition information includes, for example, a list of IDs of the users to which the re-transfer is permitted, information indicating the condition indicating whether or not re-transfer is permitted, and information indicating the condition as to whether the re-transfer destination is proper, which are pre-designated by the data administrator. As the condition as to whether the re-transfer destination is proper, for example, it can be listed that the ID of the data user of the re-transfer destination is included in the list of IDs of the users to which the re-transfer is permitted.

Further, in the case that the attribute certificate server 110 in the fifth embodiment has been connected to the second data user mobile terminal 15, as the condition as to whether the re-transfer destination is proper, it may be listed that the position (attribute) of the second data user that the attribute certificate indicates is included because the attribute certificate of the second data user is included in the use request token.

The data file means 12 of the first data user mobile terminal 14 that the first data user employs transmits the encrypted confidential data to the data file means 23 of the second data user mobile terminal 15 that the second data user employs (step S501). The encrypted confidential data is filed in the data file means 23 of the second data user mobile terminal 15.

When the second data user uses the above encrypted confidential data at the first time, the right transfer means (use request means) 21 of the second data user mobile terminal 15 generates a use request token including the data user ID and the confidential data ID for identifying the encrypted confidential data (step S502), and transmits the generated use request token to the first data user mobile terminal 14 (step S503).

Additionally, it is preferable that the use request token is transmitted so as to cause the first data user to perform a right transfer process, which is later described, in a face-to-face meeting with the second data user. Specifically, for example, the use request token is transmitted with the near-distance wireless communication such as infrared-ray communication and Bluetooth in some cases, or the second data user delivers the SD memory card or USB bar having the use request token stored therein to the first data user in some cases.

Further, for example, when the first user mobile terminal 14 has a function of reading off a two-dimension barcode, the right transfer means 21 of the second user mobile terminal 15 may cause the user input/output means 20 to display the image indicating the use request token two-dimensionally bar-coded, and may cause the first user mobile terminal 14 to read off the above the two-dimension barcode.

The second right transfer means 141 of the first user mobile terminal 14 having received the use request token extracts the right certificate that correspond hereto from the certificate file means 25 with the confidential data ID being included in the use request token taken as a key, and determines whether or not the re-transfer of the right for utilizing the confidential data to the second data user is permitted based upon the re-transfer condition information that is included in the extracted right certificate (step S504). When the second right transfer means 141 has determined not to permit the re-transfer of the right, the first user mobile terminal 14 finishes the process.

The second right transfer means 141, when having determined to permit the re-transfer of the right certificate to the second data user, causes the user input/output means (input/output means) 10 to display the use request information including the confidential data ID and data user ID that the use request token includes, and causes the first data user to perform a right transfer process (step S505). The so-called right transfer process is a process of causing the first data user to input an instruction into the user input/output means 10 of the first user mobile terminal 14 in order to authorize the second data user to use the confidential data, thereby to re-transfer the right certificate.

When the instruction for authorizing the second data user to use the confidential data has been inputted into the user input/output means 10 from the first data user, the second right transfer means 141 of the first user mobile terminal 14 generates a re-transfer authorization token that corresponds to the confidential data specified by the confidential ID (step S506), and transmits the generated re-transfer authorization token to the right management means 31 (step S507). Additionally, when the first data user does not authorize the second data user to use the confidential data, the first user mobile terminal 14 finishes the process.

The right management means 31 makes a reference to the re-transfer authorization token, generates a right certificate (hereinafter, referred to as a second right certificate) that should be delivered to the second data user (step S508), and transmits the generated second right certificate to the second user mobile terminal 15 that the second data user employs (step 3511).

Additionally, the second right certificate has the re-transfer certificate attached hereto besides the right certificate issued to the first data user by the data administrator (hereinafter, referred to as a first right certificate). FIG. 23 is an explanatory view illustrating a configuration example of the second right certificate. The re-transfer certificate includes the confidential data ID, the data user ID of the second data user, and the data user ID of the first data user. The second right certificate includes the decryption key of the encrypted confidential data because the first right certificate includes the decryption key of the encrypted confidential data.

And, the use control means 22 of the second user mobile terminal 15 having received the second right certificate files the second right certificate in the certificate file means 24, and executes a process of using the decrypted confidential data responding to an operation being inputted into the user input/output means 20 (step S509) while decrypting the encrypted confidential data filed in the data file means 23 (step S510) by employing the decryption key that the above second right certificate includes.

This embodiment makes it possible to construct the data use managing system having a higher operativeness because worker partners or person partners in charge of business can transfer the right given by the customer to each other without causing the customer to perform a special operation, for example, in the case that the second data user (for example, an alternate worker or person in charge of business) uses the confidential data of the data administrator (for example, a customer), which the first data user (for example, a worker or a person in charge of business) keeps, as a business in maintenance works or customer businesses for the reason of the first data user taking a leave.

The present invention is applicable to a business terminal that the maintenance worker or the person in charge of business is caused to carry. Further, the present invention is applicable to an application program as well that operates over the mobile terminals such as a portable telephone, a PDA, and a note-type personal computer.

Further, the present invention is applicable to a sales promotion service of a word-of-mouth communication type as well in which, in a download sales of amusement contents, a contents purchaser (data administrator) temporarily permits a friend (data user) existing in the vicinity to audit the above amusement contents.

Additionally, this application is based upon and claims the benefit of priority from Japanese patent application No. 2006-241963, filed on Sep. 6, 2006, the disclosure of which is incorporated herein in its entirety by reference.

1-17. (canceled)

18. A data use managing system, comprising:
a first data-use appliance comprising decryption means for decrypting encrypted data by employing a decryption key, and use request means for generating use request data for requesting permission of a use of the data, said use request data including encrypted data identification information, and transmitting it by near-distance wireless communication or causing display means to display said use request data;
a second data-use appliance comprising right transfer means for receiving said use request data, and identification information transmission means for transmitting administrator identification information and the encrypted data identification information that are included in the above use request data to right management means; and
the right management means comprising a database in which the decryption key, the encrypted data identification information, and the administrator identification information indicating an administrator of the encrypted data have been stored correspondingly to each other, and decryption key transmission means for transmitting the decryption key to said first data-use appliance:
wherein said second data-use appliance comprises right transfer means for acquiring the above use request data from said first data-use appliance by said near-distance wireless communication means or means for optically receiving the use request data displayed in said display means, and determining whether or not to meet a transfer condition, being a condition that a right for using the use-requested data is transferred, input/output means for causing a user of said first data-use appliance to determine whether or not said first data-use appliance is permitted to use the above data, and data transmission means for transmitting transfer authorization data including the encrypted data identification information to the right management means when said right transfer means determines that said transfer condition of the right has been met, and an instruction indicating that said first data-use appliance is permitted to use the data has been inputted into said input/output means; and
wherein said decryption key transmission means of said right management means, when having received said transfer authorization data, transmits the decryption key to said first data-use appliance, thereby enabling the second data-use appliance to authorize whether or not the first data-use appliance is permitted to decrypt said encrypted data only when users of the first and second data-use appliances face each other or stand close to each other.

19. A data use managing system according to claim 18; wherein the decryption key, the encrypted data identification information, and the administrator identification information are stored in the database correspondingly to right definition information indicating a method of using the data;
wherein the decryption key transmission means, when having received the encrypted data identification information and the administrator identification information from the data management appliance, makes a reference to said database, and transmits the decryption key and the right definition information corresponding to said received encrypted data identification information and administrator identification information to the data use appliance; and
wherein said data use appliance comprises use control means for using the data according to the use method that the received right definition information indicates.

20. A data use managing system according to claim 18;
wherein the decryption key, the encrypted data identification information, and the administrator identification information are stored in the database correspondingly to right definition information indicating a method of using the data and an output destination;
wherein the decryption key transmission means, when having received the encrypted data identification information and the administrator identification information from the data management appliance, makes a reference to said database, and transmits the decryption key and the right definition information corresponding to said received encrypted data identification information and administrator identification information to the data use appliance; and
wherein said data use appliance comprises use control means for outputting data to the output destination that said right definition information indicates, according to the use method and the output destination that the received right definition information indicates.

21. A data use managing system according to claim 20;
wherein the data use appliance comprises authentication means for authenticating a device of the output destination of the data, and outputting the data to the device of the output destination responding to an authentication result.

22. A data use managing system according to claim 21;
wherein the authentication means, when receiving from the device of the output destination of the data authentication information including information indicating the above device, and determining that the received authentication information meets a predetermined authentication rule, outputs said data to said device.

23. A data use managing system according to claim 18;
wherein the use request means of the data use appliance generates the use request data including user identification information indicating a user of the data;
wherein the data management appliance comprises data acquisition means for acquiring said use request data from the data use appliance, and input/output means for displaying the encrypted data identification information and the user identification information that said use request data acquired by said data acquisition means includes, and causing a user to input an instruction indicating whether or not said data use appliance is permitted to use the data; and
wherein the identification information transmission means of said data management appliance transmits the encrypted data identification information and the administrator identification information to the right management means when an instruction indicating that said data use appliance is permitted to use the data has been inputted into said input/output means.

24. A data use managing system according to claim 23; said data use managing system comprising attribute certificate generation means for generating an attribute certificate indicating an attribute of a user of the data responding to a request by the data use appliance:
wherein the use request means of said data use appliance generates use request data including said attribute certificate generated by said attribute certificate generation means; and
wherein the input/output means of the data management appliance displays the encrypted data identification information, the user identification information, and the attribute certificate that said use request data acquired by the data acquisition means includes, and causes a user to input an instruction indicating whether or not said data use appliance is permitted to use the data.

25. A data use managing system according to claim 18, said data use managing system comprising a right transferee appliance comprising decryption means for decrypting the encrypted data by employing the decryption key, and use request means for generating use request data for requesting permission of a use of the data, said use request data including the encrypted data identification information, and transmitting it by near-distance wireless communication or causing display means to display said use request data:
wherein the data use appliance comprises right re-transfer means for, when having acquired the use request data from said right transferee appliance, determining whether or not to meet a re-transfer condition, being a condition that a right for using the data is transferred, input/output means for causing a user of said data use appliance to determine whether or not said right transferee appliance is permitted to use the data, and data transmission means for transmitting re-transfer authorization data including the encrypted data identification information to the right management means when said right re-transfer means determines that said re-transfer condition of the right is met, and an instruction indicating that said right transferee appliance is permitted to use the data has been inputted into said input/output means; and
wherein the decryption key transmission means of said right management means, when having received said re-transfer authorization data, transmits the decryption key to said right transferee appliance.

26. A data-use appliance, comprising:
decryption means for decrypt encrypted data by employing a decryption key;
use request means for generating use request data for requesting permission of a use of the data, said use request data including encrypted data identification information, transmitting it by near-distance wireless communication or causing display means to display said use request data, and requesting an administrator of the encrypted data to use the data;
right transfer means for, when having acquired the use request data from other appliances, determining whether or not to meet a transfer condition, being a condition that a right for using the data is transferred;
input/output means for causing a user to determine whether or not said other appliances are permitted to use the data; and
data transmission means for transmitting transfer authorization data including the encrypted data identification information to right management means for transmitting the decryption key when said right transfer means determines that said transfer condition of the right has been met, and an instruction indicating that said other appliances are permitted to use the data has been inputted into said input/output means.

27. A data use appliance according to claim 26, said data use appliance comprising use control means for using the data according to right definition information indicating a method of using the data.

28. A data use appliance according to claim 26, said data use appliance comprising:
right re-transfer means for, when having acquired the use request data from other appliances, determining whether or not to meet a re-transfer condition, being a condition that a right for using the data is transferred;
input/output means for causing a user to determine whether or not said other appliances are permitted to use the data; and
data transmission means for transmitting re-transfer authorization data including the encrypted data identification information to right management means for transmitting the decryption key when said right re-transfer means determines that said re-transfer condition of the right is met, and an instruction indicating that said other appliances are permitted to use the data has been inputted into said input/output means.

29. A server, comprising:
a database in which a decryption key for decrypting encrypted data, being data that has been encrypted, encrypted data identification information for identifying the encrypted data, right definition information indicating a method of using the data, and administrator identification information indicating an administrator of the encrypted data are stored correspondingly to each other; and
decryption key transmission means for, when having received the encrypted data identification information and the administrator identification information from a first mobile appliance, transmitting to a second mobile appliance the decryption key and the right definition information caused to correspond to said encrypted data identification information and administrator identification information stored in said database.

30. A data management appliance, comprising:
data acquisition means for acquiring use request data including encrypted data identification information for identifying encrypted data and user identification information indicating a user of the data from a data use appliance for using the data, said use request data indicating a request for permitting a use of the data; and
input/output means for displaying the encrypted data identification information and the user identification information included in said acquired use request data, and causing a user to input an instruction indicating whether or not said data use appliance is permitted to use the data.

31. A data management appliance according to claim 30, said data management appliance comprising:
encrypted data generation means for encrypting the data, thereby to generate the encrypted data; and
right definition means for generating right definition information indicating a method of using the data by the data use appliance.

32. A data use managing method, comprising:
a use request step in which use request means generates use request data for requesting permission of a use of the data, said use request data including encrypted data identification information for identifying encrypted data, being data that has been encrypted, and transmits it by near-distance wireless communication or causes display means to display said use request data;
an identification information transmission step in which identification information transmission means, when having acquired the use request data, transmits administrator identification information indicating an administrator of the encrypted data and the encrypted data identification information that said use request data includes;
a decryption key transmission step in which decryption key transmission means, when having received the administrator identification information and the encrypted data identification information transmitted in the identification information transmission step, makes a reference to a database for storing a decryption key, the encrypted data identification information, and the administrator identification information correspondingly to each other, and transmits the decryption key corresponding to said received administrator identification information and encrypted data identification information; and
a decryption step in which decryption means employs the decryption key transmitted in said decryption key transmitting step, thereby to decrypt the encrypted data.

33. A program, said program causing a computer to execute:
employing a decryption key for decrypting encrypted data, being data that has been encrypted, thereby to decrypt said encrypted data; and
generating use request data for requesting permission of a use of the data, said use request data including encrypted data identification information for identifying the encrypted data, transmitting it by near-distance wireless communication or causing display means to display said use request data, and requesting an administrator of the encrypted data to use the data.

34. A program, said program causing a computer to execute:
acquiring use request data including encrypted data identification information for identifying encrypted data and user identification information indicating a user of the data from a data use appliance for using the data, said use request data indicating a request for permitting a use of the data; and
displaying the encrypted data identification information and the user identification information being included in said use request data acquired in said data acquisition process in display means, and causing a user to input an instruction indicating whether or not said data use appliance is permitted to use the data into input means.

35. A data use managing method, comprising:
a use request step in which a first data-use appliance generates use request data for requesting permission of a use of data, said use request data including encrypted data identification information for identifying encrypted data, being data that has been encrypted, and transmits it by near-distance wireless communication or causes display means to display said use request data;
to an acquisition step in which a second data-use appliance receives the use request data by said near-distance wireless communication, or optically receives the use request data displayed in said display means from said first data-use appliance, thereby to acquire the above use request data;
a right transfer step in which said second data-use appliance determines whether or not to meet a transfer condition, being a condition that a right for using the use-requested data is transferred;
a data transmission step in which said second data-use appliance transmits transfer authorization data including administrator identification information indicating an administrator of the encrypted data and the encrypted data identification information when it is determined in said right transfer step that said transfer condition of the right has been met, and an instruction indicating that said first data-use appliance is permitted to use the data has been inputted;
a decryption key transmission step in which a right management unit retrieves a decryption key caused to correspond to the administrator identification information and the encrypted data identification information being included in said received transfer authorization data from a database in which a decryption key, the encrypted data identification information, and the administrator identification information indicating an administrator of the encrypted data have been stored corresponding to each other, and transmits the retrieved decryption key to said first data-use appliance; and
a decryption step in which said first data-use appliance employs said transmitted decryption key, thereby to decrypt the encrypted data.

36. A data use managing method according to claim 35;
wherein said decryption key transmission step is a step of retrieving the decryption key and right definition information that correspond to the administrator identification information and the encrypted data identification information received from a data management appliance from a database in which the decryption key, the encrypted data identification information, the administrator identification information, and the right definition information indicating a method of using the data have been stored correspondingly to each other, and transmitting the retrieved decryption key and right definition information to the data-use appliance; and
wherein said data-use appliance uses the data according to the use method that the received right definition information indicates.

37. A data use managing method according to claim 36;
wherein said decryption key transmission step is a step of retrieving the decryption key and the right definition information corresponding to the administrator identification information and the encrypted data identification information that are included in said received transfer authorization data from a database in which the decryption key, the encrypted data identification information, the administrator identification information, and the right definition information indicating the method of using the data and an output destination have been stored correspondingly to each other, and transmitting the retrieved decryption key and right definition information to the data-use appliance; and
wherein said data-use appliance outputs the data to the output destination that said right definition information indicates, according to the use method and the output destination that the received right definition information indicates.

38. A data use managing method according to claim 37, wherein said data-use appliance authenticates a device of the output destination of the data, and outputs the data to the device of the output destination responding to an authentication result.

39. A data use managing method according to claim 38, wherein authentication means, when receiving from the device of the output destination of the data authentication information including information indicating the above device, and determining that the received authentication information meets a predetermined authentication rule, outputs said data to said device.

40. A data use managing method according to claim 35:
Wherein the first data-use appliance generates the use request data including user identification information indicating a user of the data in the data use request step;
wherein the data management appliance displays the encrypted data identification information and the user identification information that are included in said use request data acquired from the data-use appliance; and
wherein the data management appliance transmits the encrypted data identification information and the administrator identification information to the right management unit when an instruction indicating that said data-use appliance is permitted to use the data has been inputted from a user.

41. A data use managing method according to claim 40, said use management method comprising an attribute certificate generation step of generating an attribute certificate indicating an attribute of a user of the data responding to a request by the first data-use appliance:
wherein said use request step is a step of generating the use request data including said attribute certificate generated in said attribute certificate generation step;
wherein the data management appliance displays the encrypted data identification information, the user identification information, and the attribute certificate that said use request data acquired by data acquisition means includes; and
wherein the data management appliance transmits the encrypted data identification information and the administrator identification information to the right management unit when an instruction indicating that said data-use appliance is permitted to use the data has been inputted from a user.

42. A data use method, comprising:
generating use request data for requesting permission of a use of data, said use request data including encrypted data identification information for identifying encrypted data, being data that has been encrypted, transmitting it by near-distance wireless communication or causes display means to display said use request data, and requesting an administrator of the encrypted data to use the data;
determining whether or not to meet a transfer condition, being a condition that a right for using the use-requested data is transferred when acquiring the use request data from other appliances; and
transmitting transfer authorization data including the encrypted data identification information to a right management unit for transmitting a decryption key when it is determined in said right transfer step that said transfer condition of the right has been met, and an instruction indicating that said other appliances are permitted to use the data has been inputted from a user; and
employing the decryption key transmitted from said right management unit, thereby to decrypt the encrypted data.

43. A data use method according to claim 42, said data use method comprising using said decrypted data according to right definition information indicating a method of using the data.
